(19) United States
(12) Patent Application Publication
(10) Pub. No.: US 2021/0027619 A1
(43) Pub. Date: Jan. 28, 2021

(54) TRAFFIC MONITORING APPARATUS, TRAFFIC MONITORING SYSTEM, TRAFFIC MONITORING METHOD, AND NON-TRANSITORY COMPUTER READABLE MEDIUM STORING PROGRAM

(71) Applicant: NEC Corporation, Tokyo (JP)

(72) Inventor: Michihiko YUSA, Tokyo (JP)

(73) Assignee: NEC Corporation, Tokyo (JP)

(21) Appl. No.: 17/042,342

(22) PCT Filed: Mar. 26, 2019
(86) PCT No.: PCT/JP2019/012929

§ 371 Date: Sep. 28, 2020

(30) Foreign Application Priority Data
Mar. 29, 2018 (JP) 2018-066013

(51) Int. Cl. G08G 1/01; G08G 1/09

(52) U.S. Cl. CPC G08G 1/0125; G08G 1/09

(57) ABSTRACT

The vehicle information acquisition unit (11) acquires vehicle information regarding travelling states of vehicles that are present in the vicinity of a plurality of respective intersections from data received from each of a plurality of detection apparatuses (20). The congestion determination unit (13) determines, for each of the plurality of intersections, whether congestion is occurring based on the vehicle information and determines an intersection where congestion has occurred to be a congested intersection. The intersection specifying unit (15) specifies, when there is a continuous congestion path including a plurality of consecutive congested intersections, a congestion-inducing intersection, which is an intersection that has induced congestion in a continuous congestion path. The cause determination unit (14) specifies the cause of the congestion occurred in the congestion-inducing intersection.

### TECHNICAL FIELD

The present disclosure relates to a traffic monitoring apparatus, a traffic monitoring system, a traffic monitoring method, and a non-transitory computer readable medium storing a program.

### BACKGROUND ART

In emerging countries etc., concentration of the population in urban areas has been rapidly occurring along with economic growth. However, traffic infrastructure such as roads, railroads, buses and the like has not been sufficiently developed, which causes serious traffic congestion due to a rapid increase in a traffic amount. In order to deal with the above situation, there is a technique of managing actual traffic situations in a road network by a traffic control apparatus installed in a traffic control center and implementing traffic measures such as controlling signal lights installed in an intersection and sending a notification of traffic situations indicating congestion, traffic regulations or the like to drivers.

With regard to the above technique, Patent Literature 1 discloses an image-capturing system provided in an intersection. The image-capturing system according to this Patent Literature includes an overall view image-capturing unit, a tracking target specifying unit, a plurality of specific target image-capturing units, and a voice information output unit. The overall view image-capturing unit captures images of a plurality of targets that travel in an intersection and in the vicinity of the intersection. The tracking target specifying unit specifies a target to be tracked from the data captured by the overall view image-capturing unit based on predetermined conditions. The plurality of specific target image-capturing units include image-pickup elements whose image resolution is higher than that of the image-pickup elements of the overall view image-capturing unit and capture images of the target to be tracked while tracking it. The voice information output unit outputs voice information with directivity for the target to be tracked.

Further, Patent Literature 2 discloses a traffic control apparatus. The traffic control apparatus according to Patent Literature 2 stores a transition with time of a traffic situation in a target road network in a traffic situation storage unit. The traffic control apparatus according to Patent Literature 2 estimates, from the transition with time of the traffic situation, a site where a chronic traffic problem such as congestion is occurring and generates measures for eliminating the traffic problem for the estimated site. After executing the above measures, the traffic control apparatus verifies the adequacy of the measures using the actual traffic situations and uses the results of the verification as know-how when following measures are generated.

Further, Patent Literature 3 discloses a traffic system for estimating a traffic path where congestion is occurring. The traffic system disclosed in Patent Literature 3 includes traffic network data which describes connection relations between traffic paths. This traffic system specifies another traffic path connected to a traffic path that is determined to be congested based on the traffic network data, determines whether or not congestion is occurring in the other traffic path, and records the results of the determination in a congestion list along with the connection relation.

### CITATION LIST

### Patent Literature

[Patent Literature 1] Japanese Unexamined Patent Application Publication No. 2011-043943
[Patent Literature 2] Japanese Unexamined Patent Application Publication No. 2005-267269
[Patent Literature 3] Japanese Unexamined Patent Application Publication No. 2015-028675

### SUMMARY OF INVENTION

### Technical Problem

In order to deal with the problem of traffic congestion, it is required to specify the cause of the congestion. Congestion often occurs in the vicinity of an intersection where a plurality of roads intersect with each other. It is therefore required to monitor the travelling states of the vehicles in the intersection. Incidentally, it is possible that a series of congestions across a plurality of intersections may occur. As described above, when congestion occurs in a plurality of consecutive intersections, it is possible that occurrence of some cause for congestion in one intersection may lead to congestion in another intersection as well. In this case, even when countermeasures against congestion are taken for the other intersection that has become congested due to the cause for congestion which occurred in the one intersection, it is extremely difficult to eliminate congestion in the other intersection. That is, a series of congestions may not be eliminated unless countermeasures are taken against the congestion in the intersection where the original cause of the series of congestions occurred. However, none of the aforementioned Patent Literature discloses specifying the intersection where the original cause of congestion occurred when a series of congestions has occurred. Therefore, according to the techniques disclosed in the aforementioned Patent Literature, it is possible that the cause of the congestion cannot be definitely specified.

The present disclosure has been made in order to solve the aforementioned problem and an object of the present disclosure is to provide a traffic monitoring apparatus, a traffic monitoring system, a traffic monitoring method, and a program capable of determining a cause of traffic congestion more definitely.

### Solution to Problem

A traffic monitoring apparatus according to the present disclosure includes: vehicle information acquisition means for acquiring vehicle information regarding travelling states of vehicles that are present in the vicinity of a plurality of respective intersections; congestion determination means for determining, for each of the plurality of intersections, whether or not congestion is occurring based on the vehicle information and determining an intersection where the congestion has occurred to be a congested intersection; intersection specifying means for specifying, when there is a continuous congestion path including a plurality of consecutive congested intersections, a congestion-inducing intersection, which is an intersection that has induced congestion in the continuous congestion path; and cause determination means for determining the cause of the congestion that has occurred in the congestion-inducing intersection.

Further, a traffic monitoring system according to the present disclosure includes: a plurality of detection apparatuses configured to detect states of areas in the vicinity of respective intersections; and a traffic monitoring apparatus configured to monitor traffic of the intersections, in which the traffic monitoring apparatus includes: vehicle information acquisition means for acquiring vehicle information regarding travelling states of vehicles that are present in the vicinity of a plurality of respective intersections; congestion determination means for determining, for each of the plurality of intersections, whether or not congestion is occurring based on the vehicle information and determining an intersection where the congestion has occurred to be a congested intersection; intersection specifying means for specifying, when there is a continuous congestion path including a plurality of consecutive congested intersections, a congestion-inducing intersection, which is an intersection that has induced congestion in the continuous congestion path; and cause determination means for determining the cause of the congestion that has occurred in the congestion-inducing intersection.

Further, a traffic monitoring method according to the present disclosure includes: acquiring vehicle information regarding travelling states of vehicles that are present in the vicinity of a plurality of respective intersections; determining, for each of the plurality of intersections, whether or not congestion is occurring based on the vehicle information and determining an intersection where the congestion has occurred to be a congested intersection; specifying, when there is a continuous congestion path including a plurality of consecutive congested intersections, a congestion-inducing intersection, which is an intersection that has induced congestion in the continuous congestion path; and determining the cause of the congestion that has occurred in the congestion-inducing intersection.

Further, a program according to the present disclosure causes a computer to execute the following steps of: acquiring vehicle information regarding travelling states of vehicles that are present in the vicinity of a plurality of respective intersections; determining, for each of the plurality of intersections, whether or not congestion is occurring based on the vehicle information and determining an intersection where the congestion has occurred to be a congested intersection; specifying, when there is a continuous congestion path including a plurality of consecutive congested intersections, a congestion-inducing intersection, which is an intersection that has induced congestion in the continuous congestion path; and determining the cause of the congestion that has occurred in the congestion-inducing intersection.

### Advantageous Effects of Invention

According to the present disclosure, it is possible to provide a traffic monitoring apparatus, a traffic monitoring system, a traffic monitoring method, and a program capable of determining a cause of traffic congestion more definitely.

### BRIEF DESCRIPTION OF DRAWINGS

FIG. 1 is a diagram showing an outline of a traffic monitoring system according to a first example embodiment of the present disclosure;

FIG. 2 is a diagram showing the traffic monitoring system according to the first example embodiment;

FIG. 3 is a diagram illustrating a plurality of intersections where detection apparatuses according to the first example embodiment are installed;

FIG. 4 is a diagram illustrating intersections where the detection apparatuses according to the first example embodiment are installed;

FIG. 5 is a diagram showing a configuration of a traffic monitoring apparatus according to the first example embodiment;

FIG. 6 is a flowchart showing a traffic monitoring method executed by the traffic monitoring apparatus according to the first example embodiment;

FIG. 7 is a diagram illustrating a congestion determination method performed by a congestion determination unit according to the first example embodiment;

FIG. 8 is a diagram illustrating a cause determination method performed by a cause determination unit according to the first example embodiment;

FIG. 9 is a diagram for describing a cause determination method according to the first example embodiment;

FIG. 10 is a diagram for describing an example of a relation between a traffic obstacle and a congestion cause;

FIG. 11 is a diagram for describing an example of a relation between a traffic obstacle and a congestion cause;

FIG. 12 is a diagram for describing an example of a relation between a traffic obstacle and a congestion cause;

FIG. 13 is a diagram for describing an example of a relation between a traffic obstacle and a congestion cause;

FIG. 14 is a diagram for describing an example of a relation between a traffic obstacle and a congestion cause;

FIG. 15 is a diagram for describing an example of a relation between a traffic obstacle and a congestion cause;

FIG. 16 is a diagram for describing an example of a relation between a traffic obstacle and a congestion cause;

FIG. 17 is a diagram illustrating countermeasure information according to the first example embodiment;

FIG. 18 is a diagram showing an outline of a traffic monitoring system according to a second example embodiment of the present disclosure;

FIG. 19 is a diagram showing a configuration of a traffic monitoring apparatus according to the second example embodiment;

FIG. 20 is a flowchart showing a traffic monitoring method executed by the traffic monitoring apparatus according to the second example embodiment;

FIG. 21 is a flowchart illustrating a method of specifying a congestion-inducing intersection performed by an intersection specifying unit according to the second example embodiment;

FIG. 22 is a diagram illustrating a continuous congestion path; and FIG. 23 is a diagram showing an example of the continuous congestion path in a road network.

### DESCRIPTION OF EMBODIMENTS

### Outline of First Example Embodiment

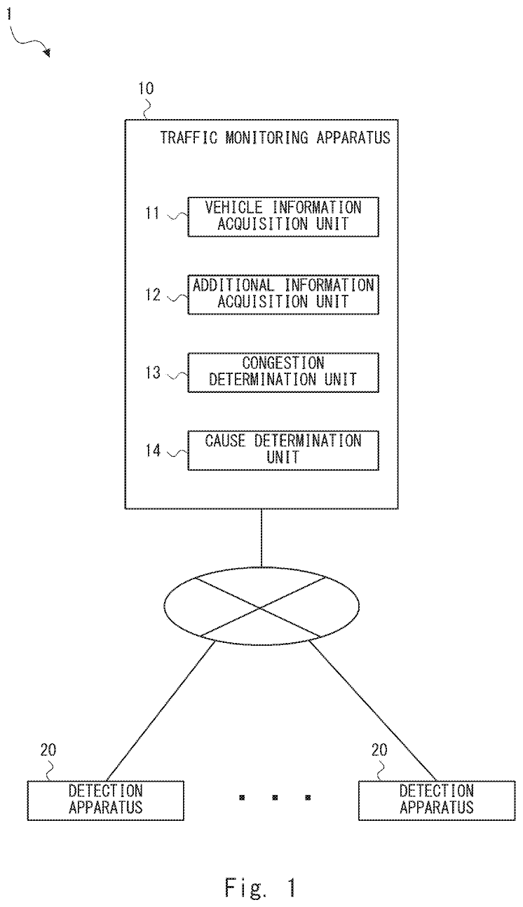

Prior to giving a description of a first example embodiment of the present disclosure, an outline of the first example embodiment according to the present disclosure will be described. FIG. 1 is a diagram showing the outline of a traffic monitoring system 1 according to the first example embodiment of the present disclosure. The traffic monitoring system 1 includes a traffic monitoring apparatus 10 and at least one detection apparatus 20. The detection apparatus 20 and the traffic monitoring apparatus 10 are connected to each other in such a way that they can communicate with each other via a wired or wireless network.

The detection apparatus 20 is, for example, a camera, a sensor or the like. The detection apparatus 20 detects a state of an area in the vicinity of an intersection and transmits data indicating the results of the detection to the traffic monitoring apparatus 10. When the detection apparatus 20 is a camera, the detection apparatus 20 transmits images (image data) obtained by capturing images of surroundings of the intersection to the traffic monitoring apparatus 10. In the following description, the term “image” may also indicate “image data indicating images”, which is a processing target in information processing. Further, the images may either be still images or moving images.

The traffic monitoring apparatus 10 monitors the traffic of at least one intersection where the detection apparatus 20 is installed. The traffic monitoring apparatus 10 includes a vehicle information acquisition unit 11 (vehicle information acquisition means), an additional information acquisition unit 12 (additional information acquisition means), a congestion determination unit 13 (congestion determination means), and a cause determination unit 14 (cause determination means). The vehicle information acquisition unit 11 acquires vehicle information regarding the travelling states of vehicles that are present in the vicinity of the intersection from the data received from the detection apparatus 20. The additional information acquisition unit 12 acquires additional information regarding objects that are other than the travelling vehicles and are present in the vicinity of the intersection. The congestion determination unit 13 determines, for each of a plurality of lanes of a road crossing the intersection, whether congestion is occurring based on the vehicle information. The cause determination unit 14 determines the cause of the congestion in the lane which has been determined to be congested based on at least the additional information.

As described above, the traffic monitoring apparatus 10 according to the first example embodiment of the present disclosure determines, for each of a plurality of lanes of a road crossing the intersection, whether or not congestion is occurring and determines the cause of the congestion in the lane which has been determined to be congested. Therefore, the traffic monitoring system 1 according to the first example embodiment of the present disclosure is able to determine the cause of the congestion more definitely. Therefore, it becomes possible to examine countermeasures against congestion more appropriately. By using the traffic monitoring system 1 according to the first example embodiment of the present disclosure as well, it becomes possible to determine the cause of the congestion more definitely. Further, by using a traffic monitoring method executed in the traffic monitoring apparatus 10 according to the first example embodiment of the present disclosure and a program that executes the traffic monitoring method as well, it becomes possible to determine the cause of the congestion more definitely.

### First Example Embodiment

Hereinafter, with reference to the drawings, example embodiments will be described. For the sake of clarification of the description, the following description and the drawings are omitted and simplified as appropriate. Throughout the drawings, the same elements are denoted by the same reference symbols and overlapping descriptions are omitted as appropriate.

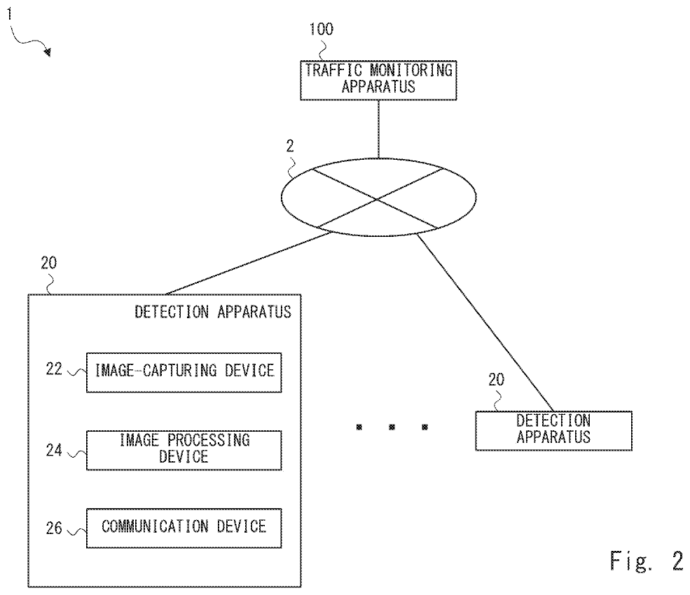

FIG. 2 is a diagram showing a traffic monitoring system 1 according to a first example embodiment. The traffic monitoring system 1 is formed of a plurality of detection apparatuses 20 and a traffic monitoring apparatus 100. The traffic monitoring apparatus 100 corresponds to the traffic monitoring apparatus 10 shown in FIG. 1. Each of the plurality of detection apparatuses 20 and the traffic monitoring apparatus 100 are connected to each other in such a way that they can communicate with each other via a wired or wireless network 2. The detection apparatus 20 may be installed in the vicinity of an intersection.

As described above, the detection apparatus 20 is, for example, a camera, a sensor or the like. In the following description, a case in which the detection apparatus 20 is a camera (monitoring camera) is shown. The detection apparatus 20 transmits images obtained by capturing images of the state of an area in the vicinity of the intersection (intersection images) to the traffic monitoring apparatus 100. The detection apparatus 20 includes an image-capturing device 22, an image processing device 24, and a communication device 26. The image-capturing device 22 is, for example, a camera body. The image-capturing device 22 may be a fixed camera, a PTZ (Pan/Tilt/Zoom) camera, or may include both of them. The image-capturing device 22 captures images of an area in the vicinity of the intersection in which the detection apparatus 20 is installed.

The image processing device 24 performs necessary image processing on the intersection images captured by the image-capturing device 22. The communication device 26 may include a router and the like. The communication device 26 transmits the intersection images on which image processing has been performed by the image processing device 24 to the traffic monitoring apparatus 100 via the network 2. In this case, the communication device 26 transmits identification information regarding the detection apparatus 20 or the intersection where the detection apparatus 20 is installed in association with the intersection images to the traffic monitoring apparatus 100. Accordingly, the traffic monitoring apparatus 100 is able to determine regarding which intersection the received intersection images relate to.

The traffic monitoring apparatus 100 monitors traffic of a plurality of intersections where the detection apparatuses 20 are installed. The traffic monitoring apparatus 100, which is installed in a traffic control center or the like, is used by an operator who monitors the traffic. The traffic monitoring apparatus 100 determines the cause of the congestion using the image data (intersection images) transmitted from each of the detection apparatuses 20 and presents a countermeasure method against congestion.

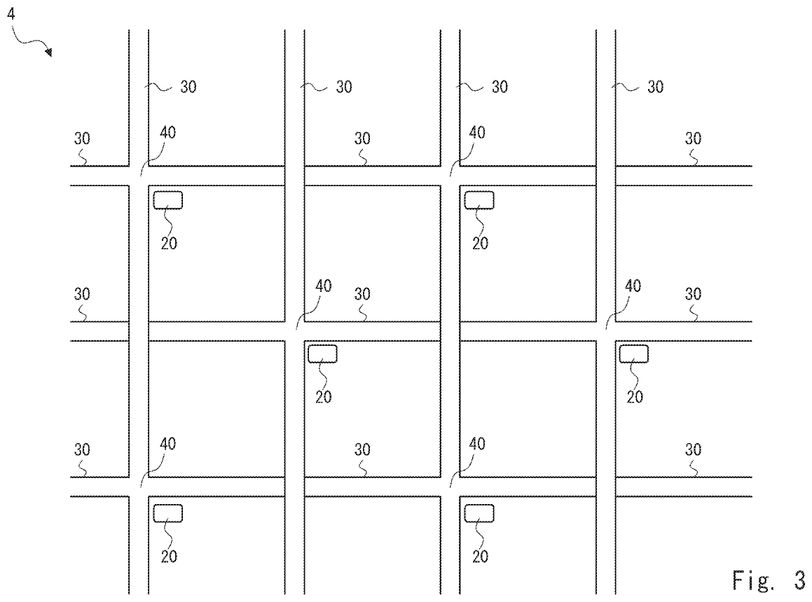

FIG. 3 is a diagram illustrating a plurality of intersections where the detection apparatuses 20 according to the first example embodiment are installed. As illustrated in FIG. 3, a plurality of roads 30 intersect with each other at a plurality of intersections 40 in a road network 4. That is, the plurality of roads 30 intersect with each other, whereby the intersections 40 are formed. Then the detection apparatuses 20 are installed in the vicinity of the respective intersections 40. The traffic monitoring apparatus 100 monitors traffic for each of the plurality of intersections 40 using the intersection images and the identification information associated with the intersection images.

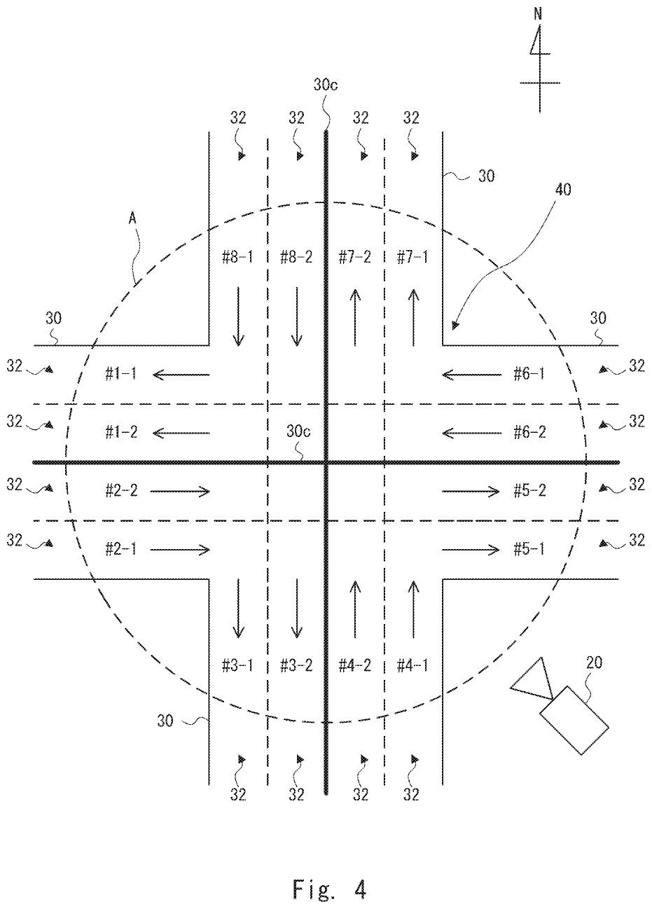

FIG. 4 is a diagram illustrating the intersection 40 where the detection apparatus 20 according to the first example embodiment is installed. While the intersection 40, which is a crossroad (a junction of four roads), is shown in FIG. 4, the intersection 40 is not limited to a crossroad. The intersection 40 may be a junction of three roads or may be a junction of multiple roads such as a junction of five roads, or may be a rotary intersection. The detection apparatus 20 may capture images of a range (range A) indicated by a broken circle A.

Each of the roads 30 includes a plurality of lanes 32. FIG. 4 shows an example in which the roads 30 each having two lanes 32 on one side with respect to a center line 30c of the road 30 (i.e., four back-and-forth lanes) intersect with each other in the intersection 40. However, the number of lanes 32 included in one road 30 may be any number equal to or greater than two. Further, while an example of right-hand traffic in which vehicles travel on the right side is shown in this example embodiment, the traffic may be left-hand traffic. It is assumed in FIG. 4 that the right side of the intersection 40 is the east, the left side thereof is the west, the upper side thereof is the north, and the lower side thereof is the south. That is, one intersection 40 includes lanes 32 with eight vehicle travelling directions. The detection apparatus 20 constantly captures images of the lanes 32 in eight directions in the vicinity of the intersection 40. Then the traffic monitoring apparatus 100 constantly monitors, for each of the intersections 40, the lanes 32 in the eight directions in the vicinity of the intersection 40.

Further, the lanes 32 through which vehicles travel from the intersection 40 to the west are denoted by lanes #1-1 and #1-2. The lane 32 that is far from the center line 30c is denoted by the lane #1-1 and the lane 32 that is closer to the center line 30c is denoted by the lane #1-2. The lanes 32 through which vehicles travel from the west to the intersection 40 are denoted by lanes #2-1 and #2-2. The lane 32 that is far from the center line 30c is denoted by the lane #2-1 and the lane 32 that is closer to the center line 30c is denoted by the lane #2-2. The lanes 32 through which vehicles travel from the intersection 40 to the south are denoted by lanes #3-1 and #3-2. The lane 32 that is far from the center line 30c is denoted by the lane #3-1 and the lane 32 that is closer to the center line 30c is denoted by the lane #3-2. The lanes 32 through which vehicles travel from the south to the intersection 40 are denoted by lanes #4-1 and #4-2. The lane 32 that is far from the center line 30c is denoted by the lane #4-1 and the lane 32 that is closer to the center line 30c is denoted by the lane #4-2.

Further, the lanes 32 through which vehicles travel from the intersection 40 to the east are denoted by lanes #5-1 and #5-2. The lane 32 that is far from the center line 30c is denoted by the lane #5-1 and the lane 32 that is closer to the center line 30c is denoted by the lane #5-2. The lanes 32 through which vehicles travel from the east to the intersection 40 are denoted by lanes #6-1 and #6-2. The lane 32 that is far from the center line 30c is denoted by the lane #6-1 and the lane 32 that is closer to the center line 30c is denoted by the lane #6-2. The lanes 32 through which vehicles travel from the intersection 40 to the north are denoted by lanes #7-1 and #7-2. The lane 32 that is far from the center line 30c is denoted by the lane #7-1 and the lane 32 that is closer to the center line 30c is denoted by the lane #7-2. The lanes 32 through which vehicles travel from the north to the intersection 40 are denoted by lanes #8-1 and #8-2. The lane 32 that is far from the center line 30c is denoted by the lane #8-1 and the lane 32 that is closer to the center line 30c is denoted by the lane #8-2. As described above, a total of 16 lanes 32 intersect in the intersection 40.

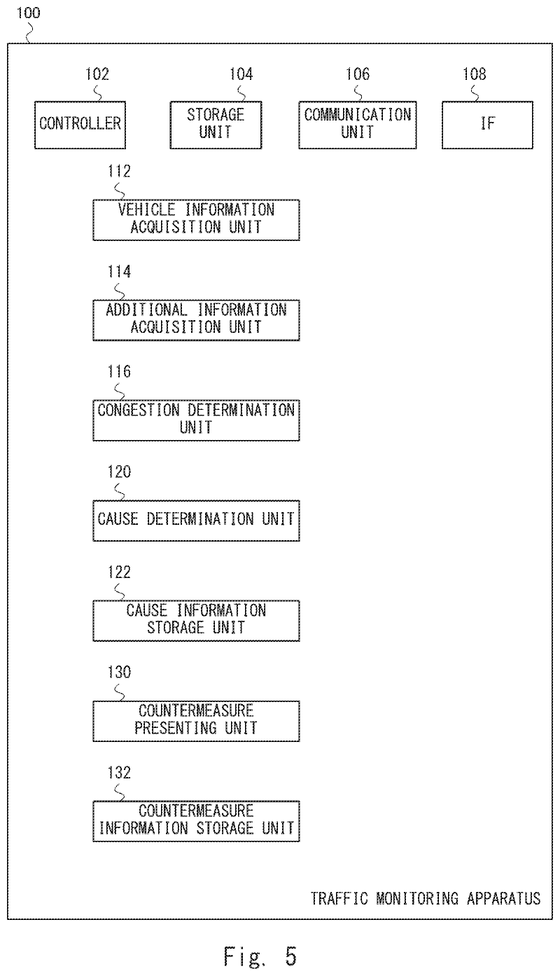

FIG. 5 is a diagram showing a configuration of the traffic monitoring apparatus 100 according to the first example embodiment. The traffic monitoring apparatus 100 includes, as a main hardware configuration, a controller 102, a storage unit 104, a communication unit 106, and an interface unit 108 (IF; Interface). The controller 102, the storage unit 104, the communication unit 106, and the interface unit 108 are connected to one another via a data bus or the like.

The controller 102 is, for example, a processor such as a Central Processing Unit (CPU). The controller 102 has a function as an arithmetic device that performs control processing, arithmetic processing and the like. The storage unit 104 is, for example, a storage device such as a memory, a hard disc or the like. The storage unit 104 is, for example, a Read Only Memory (ROM), a Random Access Memory (RAM) or the like. The storage unit 104 has a function of storing a control program, an arithmetic program and the like executed by the controller 102. Further, the storage unit 104 has a function of temporarily storing processing data or the like. The storage unit 104 may include a database.

The communication unit 106 performs processing that is necessary to perform communication with the detection apparatus 20 (and another apparatus) via the network 2. The communication unit 106 may include a communication port, a router, a firewall and the like. The interface unit 108 (IF; Interface) is, for example, a user interface (UI). The interface unit 108 includes an input device such as a keyboard, a touch panel, a mouse or the like and an output device such as a display, a speaker or the like. The interface unit 108 accepts a data input operation by a user (operator) and outputs information to the user. The interface unit 108 may display images received from the detection apparatus 20 (intersection images), a map indicating a place where congestion has occurred, the cause of the congestion, a countermeasure method and the like.

Further, the traffic monitoring apparatus 100 includes a vehicle information acquisition unit 112, an additional information acquisition unit 114, a congestion determination unit 116, a cause determination unit 120, a cause information storage unit 122, a countermeasure presenting unit 130, and a countermeasure information storage unit 132 (hereinafter each of them is referred to as “each of the components”). The vehicle information acquisition unit 112, the additional information acquisition unit 114, the congestion determination unit 116, and the cause determination unit 120 respectively serve as vehicle information acquisition means, additional information acquisition means, congestion determination means, and cause determination means. Further, the cause information storage unit 122, the countermeasure presenting unit 130, and the countermeasure information storage unit 132 respectively serve as cause information storage means, countermeasure presenting means, and countermeasure information storage means.

Each of the components may be provided, for example, by executing a program under a control by the controller 102. More specifically, each of the components may be provided by the controller 102 executing the program stored in the storage unit 104. Further, each of the components may be provided by storing a necessary program in a desired non-volatile storage medium and installing it as necessary. Further, each of the components is not limited to being implemented by software by a program and may be implemented by, for example, any combination of hardware, firmware, and software. Further, each of the components may be provided, for example, by using a user programmable integrated circuit such as a field-programmable gate array (FPGA) or a microcomputer. In this case, a program formed of each of the aforementioned components may be provided using the above integrated circuit. The same is applicable to other example embodiments that will be described later. The specific functions of the respective components will be described later.

The vehicle information acquisition unit 112 corresponds to the vehicle information acquisition unit 11 shown in FIG. 1. The vehicle information acquisition unit 112 acquires vehicle information regarding travelling states of vehicles that are present in the vicinity of the intersection 40 from the image data received from the detection apparatus 20 by image recognition or the like. In this case, the vehicle information acquisition unit 112 acquires the vehicle information for each of the plurality of lanes 32 crossing the intersection 40. The “vehicle information” here is information used to determine whether or not congestion is occurring in the vicinity of the intersection 40. The vehicle information is, for example, a traffic amount, an average travelling speed of the vehicle, an average waiting time of the vehicle within a predetermined range (range A in FIG. 4) of the intersection 40 or the like. The vehicle information may indicate the capacity (intersection capacity) indicating the number of vehicles 50 that the intersection 40 allows to pass.

The additional information acquisition unit 114 corresponds to the additional information acquisition unit 12 shown in FIG. 1. The additional information acquisition unit 114 acquires additional information regarding objects that are other than the travelling vehicles and are present in the vicinity of the intersection 40. The “objects other than the travelling vehicles” include, for example, pedestrians and light vehicles (bicycles etc.) in the intersection 40, a blocking vehicle which blocks the intersection 40, a parked vehicle which is parked in the vicinity of the intersection 40, an accident vehicle which is stopped due to some trouble (a traffic accident, a failure etc.) in the vicinity of the intersection 40, a falling object and the like. The “objects other than the travelling vehicles” further include traffic lights installed in the intersection 40. The additional information, which is information other than the vehicle information, is used to determine the cause of the congestion.

The congestion determination unit 116 corresponds to the congestion determination unit 13 shown in FIG. 1. The congestion determination unit 116 determines, for each of the plurality of lanes 32 of the roads 30 that intersect with the intersection 40, whether congestion is occurring using the vehicle information. The place where congestion is occurring is referred to as a congestion occurring place.

The cause determination unit 120 corresponds to the cause determination unit 14 shown in FIG. 1. The cause determination unit 120 determines, for the lane 32 which has been determined to be congested, the cause of the congestion (congestion cause) using at least the additional information. The cause information storage unit 122 stores congestion cause information, which is a database indicating candidates for the congestion cause. In the congestion cause information, a traffic obstacle indicated by the additional information etc. and the congestion cause are associated with each other.

The cause determination unit 120 may determine whether or not the congestion occurring place is a congestion induced place where congestion has been induced and determine the congestion cause for the congestion induced place. The “congestion induced place” here means a place where congestion has occurred due to some cause occurred in this place. In other words, the cause of the congestion occurred in a place where congestion has occurred although it is not the congestion induced place is that congestion has spread due to congestion occurred in another place (congestion induced place). As described above, by taking countermeasures for the congestion induced place by determining the cause of the congestion for the congestion induced place, it is possible that congestion may be eliminated in the other congestion occurring place as well. Therefore, in the first example embodiment, it is possible to efficiently eliminate congestion.

Further, the countermeasure information storage unit 132 stores countermeasure information. In the countermeasure information, the congestion cause and the countermeasure method are associated with each other. Specific examples of the countermeasure information will be described later. The countermeasure presenting unit 130 presents the countermeasure method against the congestion cause using the countermeasure information. The countermeasure presenting unit 130 displays, for example, the countermeasure method on the interface unit 108. As described above, the countermeasure presenting unit 130 presents the countermeasure method against congestion to the user (operator), whereby it is possible to easily take countermeasures without depending on the operator's know-how.

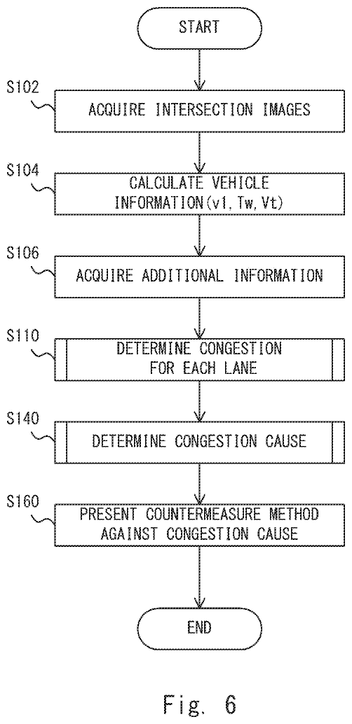

FIG. 6 is a flowchart showing a traffic monitoring method executed by the traffic monitoring apparatus 100 according to the first example embodiment. First, the traffic monitoring apparatus 100 acquires the intersection images from each of the plurality of detection apparatuses 20 (Step S102). Specifically, the communication unit 106 of the traffic monitoring apparatus 100 receives the intersection images from each of the detection apparatuses 20. Accordingly, the vehicle information acquisition unit 112 acquires the intersection images transmitted from each of the detection apparatuses 20.

Next, the vehicle information acquisition unit 112 calculates vehicle information regarding the intersection that corresponds to the intersection images using the intersection images and the identification information associated with the intersection images (Step S104). As described above, the vehicle information is, for example, an average travelling speed v1 of the vehicle, an average waiting time Tw of the vehicle, and a traffic amount Vt. Specifically, the vehicle information acquisition unit 112 performs image recognition on the intersection images and specifies the respective vehicles that travel on a plurality of lanes 32 connected to the intersection 40. Then the vehicle information acquisition unit 112 calculates the travelling speed and the waiting time for each vehicle. The travelling speed is a speed at which one vehicle passes one site of one lane 32 (e.g., in the vicinity of the boundary between the lane 32 and the intersection 40). The waiting time is a staying time during which one vehicle stays in each lane 32 within a predetermined range (the range A in FIG. 4) of the intersection 40.

The vehicle information acquisition unit 112 calculates, for each lane 32, the travelling speed for each of vehicles that have passed within a predetermined period of time (e.g., 15 minutes) and averages them, thereby calculating the average travelling speed v1. In a similar way, the vehicle information acquisition unit 112 calculates, for each lane 32, the waiting time for each of the vehicles that have passed within a predetermined period of time (e.g., 15 minutes) and averages them, thereby calculating the average waiting time Tw. The vehicle information acquisition unit 112 further calculates, for each lane 32, the number of vehicles N that have passed one site (e.g., in the vicinity of the boundary between the lane 32 and the intersection 40) per unit time (e.g., 15 minutes), thereby calculating the traffic amount Vt. As described above, the vehicle information acquisition unit 112 acquires the vehicle information by performing image recognition on the intersection images, whereby it is possible to automatically perform the determination of the congestion.

Next, the additional information acquisition unit 114 acquires additional information using the intersection images and the identification information associated with the intersection images (Step S106). Specifically, the additional information acquisition unit 114 recognizes images of pedestrians, light vehicles and the like included in the intersection images and extracts these images by image processing. The additional information acquisition unit 114 further recognizes images of a blocking vehicle, a parked vehicle, an accident vehicle, a falling object or the like included in the intersection images and extracts these images by image processing. The additional information acquisition unit 114 further receives information regarding lighting intervals from the traffic lights installed in the intersection 40. As described above, the vehicle information acquisition unit 112 analyzes the images of the intersection images or receives information regarding the lighting intervals from the traffic lights, whereby it is possible to automatically determine the congestion cause.

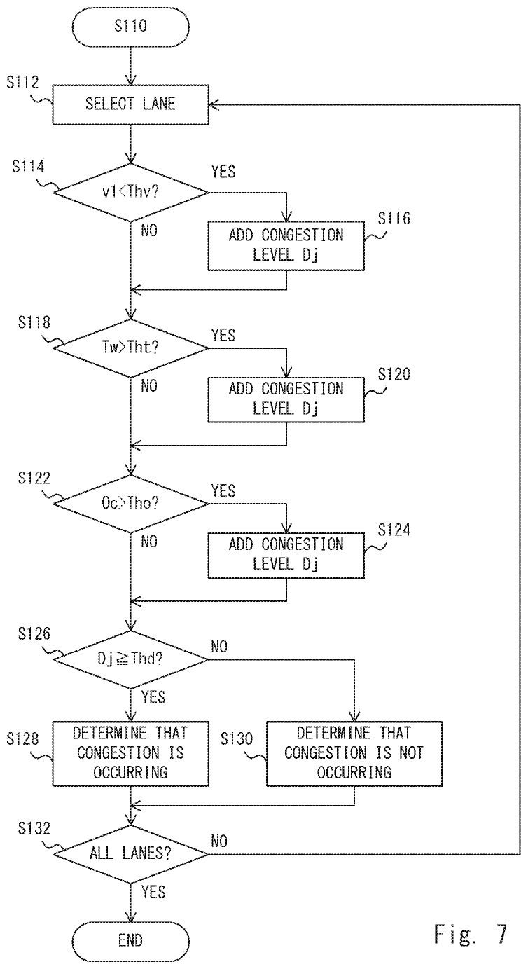

Next, the congestion determination unit 116 determines whether or not congestion is occurring for each lane 32 of each intersection 40 (Step S110). Specifically, the congestion determination unit 116 determines, for each lane 32 of each intersection 40, whether or not congestion is occurring by a method illustrated in FIG. 7. Note that the method of determining the congestion is not limited to the example shown in FIG. 7.

FIG. 7 is a diagram illustrating a congestion determination method performed by the congestion determination unit 116 according to the first example embodiment. The congestion determination unit 116 performs the congestion determination method illustrated in FIG. 7 for each of the plurality of intersections 40 using the identification information added to the intersection images. First, the congestion determination unit 116 selects the lane 32 to be determined (e.g., the lane #1-1) (Step S112). The following processing is performed for the selected lane 32 in S114 to S130.

The congestion determination unit 116 determines whether or not the average travelling speed v1 is below a predetermined threshold Thy (Step S114). For example, Thv=20 km/h. When it is determined that the average travelling speed v1 is below the threshold Thy (YES in S114), the congestion determination unit 116 adds a congestion level Dj (Step S116). The added value may be set as appropriate depending on how much emphasis should be placed on the average travelling speed v1 when the congestion is determined.

The congestion level Dj is a parameter indicating the degree of the congestion. As congestion becomes severer, the congestion level Dj becomes larger. The initial value of the congestion level Dj is set to 0. The number of thresholds Thy is not limited to one and may be plural. In this case, the congestion level Dj may be added in stages as well. Assume a case in which, for example, Thv1=20 km/h, Thv2=10 km/h, and Thv3=5 km/h. In this case, the congestion level Dj may be incremented by “1” when 10≤v1<20 is satisfied. Further, the congestion level Dj may be incremented by “2” when 5≤v1<10 is satisfied. Further, the congestion level Dj may be incremented by “3” when v1<5 is satisfied.

Next, the congestion determination unit 116 determines whether or not the average waiting time Tw exceeds a predetermined threshold Tht (Step S118). It is assumed, for example, that Tht is 240 seconds. When it has been determined that the average waiting time Tw exceeds the threshold Tht (YES in S118), the congestion determination unit 116 adds the congestion level Dj (Step S120). The added value may be set as appropriate depending on how much emphasis should be placed on the average waiting time Tw when the congestion is determined.

The number of thresholds Tht is not limited to one and may be plural. In this case, the congestion level Dj may be added in stages as well. It is assumed, for example, that Tht1 is 240 seconds, Tht2 is 360 seconds, and Tht3 is 480 seconds. In this case, the congestion level Dj may be incremented by “1” when 240<Tw≤360 is satisfied. Further, the congestion level Dj may be incremented by “2” when 360<Tw≤480 is satisfied. Further, the congestion level Dj may be incremented by “3” when 480<Tw is satisfied.

Next, the congestion determination unit 116 determines whether or not an occupation rate Oc exceeds a predetermined threshold Tho (Step S122). It is assumed, for example, that Tho is 40%. When it has been determined that the occupation rate Oc exceeds the threshold Tho (YES in S122), the congestion determination unit 116 adds the congestion level Dj (Step S124). The added value may be set as appropriate depending on how much emphasis should be placed on the occupation rate Oc when the congestion is determined.

The occupation rate here is, for example, a time occupation rate, and indicates the rate of time during which a vehicle is present in the observation time (e.g., 15 minutes) in one site. The occupation rate Oc is indicated, for example, by the following Expression 1.

$$Oc = {\sum }_{i = 1}^{n} \frac{{t}_{i}}{T} \times 100 = \frac{1}{T} {\sum }_{i = 1}^{n} \frac{{l}_{i}}{{v}_{i}} \times 100 \qquad ( Expression 1 )$$

The symbol T denotes an observation time. Further, the symbol n denotes the number of vehicles (traffic amount) that have passed one site during an observation time T. Further, tᵢ denotes a time during which the vehicle i has been present in one site. Further, vᵢ denotes the speed at which the vehicle i passes. Further, denotes the length of the vehicle i.

Note that the number of thresholds Tho is not limited to one and may be plural. In this case, the congestion level Dj may be added in stages as well. It is assumed, for example, that Tho1 is 40%, Tho2 is 45%, and Tho3 is 50%. In this case, the congestion level Dj may be incremented by “1” when 40≤Oc≤45 is satisfied. Further, the congestion level Dj may be incremented by “2” when 45<Oc≤50 is satisfied. Further, the congestion level Dj may be incremented by “3” when 50<Oc is satisfied.

Next, the congestion determination unit 116 determines whether or not the congestion level Dj is equal to or larger than the predetermined threshold Thd (Step S126). When the congestion level Dj is equal to or larger than the threshold Thd (YES in S126), the congestion determination unit 116 determines that congestion is occurring in this lane 32 (Step S128). On the other hand, when the congestion level Dj is not equal to or larger than the threshold Thd (NO in S126), the congestion determination unit 116 determines that congestion is not occurring in this lane 32 (Step S130).

The method of determining the threshold Thd is set as appropriate in accordance with criteria for determining congestion. When, for example, it is determined that there is congestion if all the determinations of S114, S122, and S126 are satisfied, it may be defined that 1 is added when each process is satisfied and Thd may be set to 3. Further, when it is determined that there is congestion if any one of the determinations of S114, S122, and S126 is satisfied, it may be defined that 1 is added when each process is satisfied and Thd may be set to 1.

Next, the congestion determination unit 116 determines whether or not congestion determination processing has been performed for all the lanes 32 (Step S132). When the congestion determination processing has not been performed for all the lanes 32 (NO in S132), the process goes back to the processing of S112. On the other hand, when the congestion determination processing has been performed for all the lanes 32 (YES in S132), the congestion determination unit 116 ends the processing for the intersection 40.

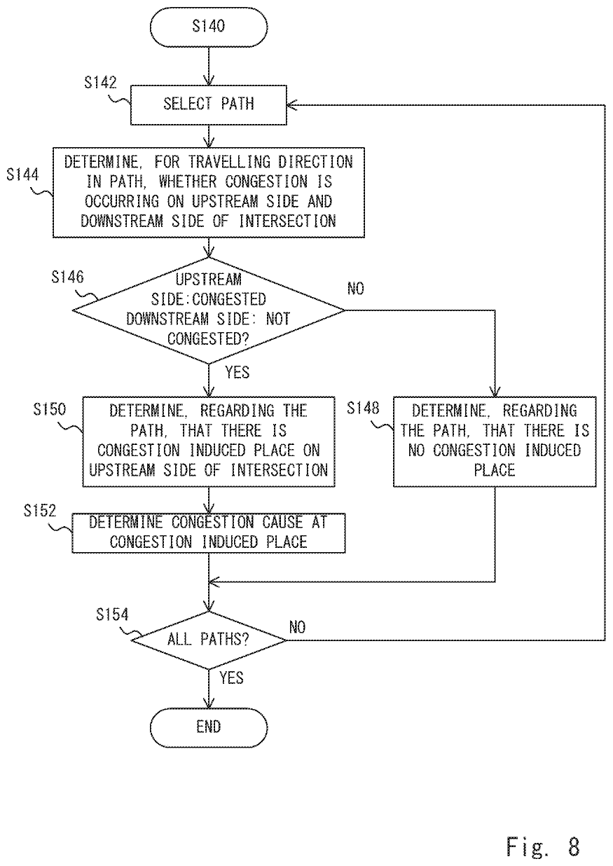

Next, the cause determination unit 120 determines, for each of the intersections 40, the congestion cause of the place where congestion is occurring (Step S140). Specifically, the cause determination unit 120 determines, for each of the intersections 40, the congestion cause by a method illustrated in FIG. 8. The method of determining the congestion cause is not limited to the example shown in FIG. 8.

FIG. 8 is a diagram illustrating a cause determination method performed by the cause determination unit 120 according to the first example embodiment. The cause determination unit 120 performs, for each of the plurality of intersections 40, the cause determination method illustrated in FIG. 8 using identification information added to the intersection images. In this case, the cause determination unit 120 determines whether or not the place (lane 32) where congestion is occurring is the congestion induced place where congestion has been induced, and determines the cause of the congestion for this congestion induced place.

First, the cause determination unit 120 selects, for the intersection 40 to be determined, one from all the paths including the place (lane 32) determined to be congested (Step S142). The “path” here includes not only a straight travelling path but also a right-turn path and a left-turn path that crosses the opposite lane.

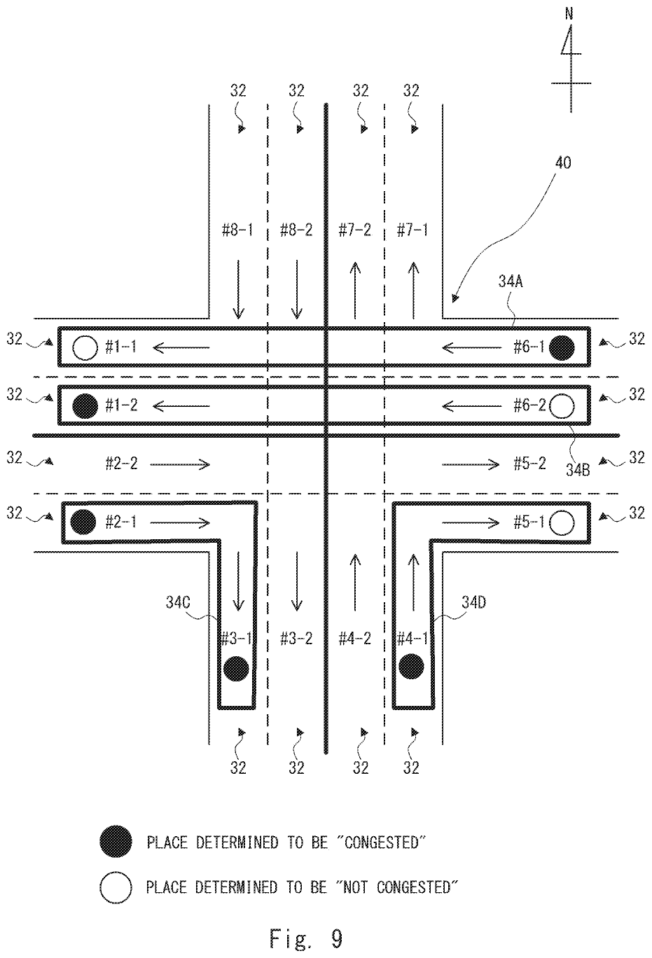

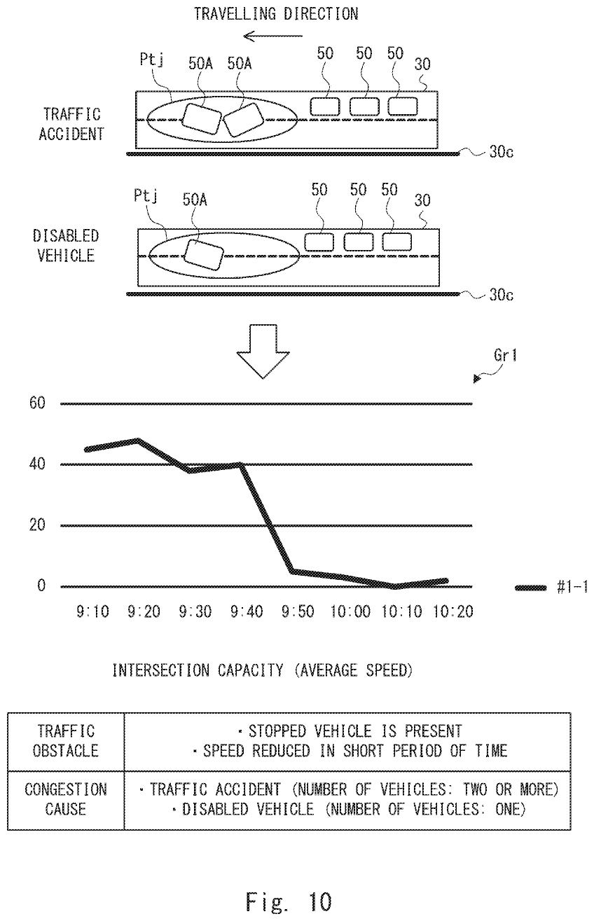

FIG. 9 is a diagram for describing the cause determination method according to the first example embodiment. FIG. 9 illustrates paths 34A to 34D. The path 34A is a straight travelling path from the lane #6-1 to the lane #1-1. That is, in the path 34A, the lane #6-1 is on the upstream side and the lane #1-1 is on the downstream side. The path 34B is a straight travelling path from the lane #6-2 to the lane #1-2. That is, in the path 34B, the lane #6-2 is on the upstream side and the lane #1-2 is on the downstream side. The path 34C is a right-turn path from the lane #2-1 to the lane #3-1. That is, in the path 34C, the lane #2-1 is on the upstream side and the lane #3-1 is on the downstream side. The path 34D is a right-turn path from the lane #4-1 to the lane #5-1. That is, in the path 34D, the lane #4-1 is on the upstream side and the lane #5-1 is on the downstream side.

Next, the cause determination unit 120 determines, for the travelling direction of vehicles in the selected path, whether or not congestion is occurring on the upstream side and the downstream side of the intersection 40 (Step S144). The cause determination unit 120 determines if congestion is occurring on the upstream side of the intersection 40 and determines if congestion is not occurring on the downstream side of the intersection 40 (Step S146).

When congestion is not occurring on the upstream side of the intersection 40 (NO in S146), the cause determination unit 120 determines, regarding this path, that there is no congestion induced place where congestion has been induced (Step S148). Further, when congestion is occurring on both the upstream side and the downstream side of the intersection 40 (NO in S146), the cause determination unit 120 determines, regarding this path, that there is no congestion induced place (Step S148). On the other hand, when congestion is occurring on the upstream side of the intersection 40 and congestion is not occurring on the downstream side of the intersection 40 (YES in S146), the cause determination unit 120 determines, regarding this path, that there is a congestion induced place where congestion has been induced on the upstream side of the intersection 40 (Step S150). The expression “there is no congestion induced place” means that, regarding the above path, the cause of the congestion has occurred in another intersection 40 on the downstream side, not in the vicinity of the intersection 40.

In the example shown in FIG. 9, in the path 34A, congestion occurs in the lane #6-1, which is on the upstream side of the intersection 40 and congestion is not occurring in the lane #1-1, which is on the downstream side thereof. Therefore, regarding the path 34A, the cause determination unit 120 determines that there is a congestion induced place in the lane #6-1, which is on the upstream side of the intersection 40. In the path 34B, congestion is not occurring in the lane #6-2, which is on the upstream side of the intersection 40, and congestion is occurring in the lane #1-2, which is on the downstream side thereof. Therefore, regarding the path 34B, the cause determination unit 120 determines that there is no congestion induced place in the vicinity of the intersection 40 and determines that there is a congestion induced place in the intersection 40 etc. which is beyond the path 34B (the westerly direction).

Further, in the path 34C, congestion is occurring in the lane #2-1, which is on the upstream side of the intersection 40 and congestion is occurring also in the lane #3-1, which is on the downstream side thereof. Therefore, regarding the path 34C, the cause determination unit 120 determines that there is no congestion induced place in the vicinity of the intersection 40 and determines that there is a congestion induced place in the intersection 40 etc. which is beyond the path 34C (the southerly direction). In the path 34D, congestion is occurring in the lane #4-1, which is on the upstream side of the intersection 40 and congestion is not occurring in the lane #5-1, which is on the downstream side thereof. Therefore, regarding the path 34D, the cause determination unit 120 determines that there is a congestion induced place in the lane #4-1, which is on the upstream side of the intersection 40.

By determining the congestion induced place like in the processing of S144 to S150, the traffic monitoring apparatus 100 according to the first example embodiment is able to determine whether or not the original cause of congestion has occurred in the vicinity of the intersection 40. Therefore, it is possible to prevent the waste of taking countermeasures against the intersection 40 when the original cause of congestion has not occurred in the vicinity of the intersection 40, i.e., when the original cause of congestion has occurred in another place. Therefore, the traffic monitoring apparatus 100 according to the first example embodiment is able to efficiently implement countermeasures against the congestion cause.

Next, the cause determination unit 120 determines the congestion cause at the congestion induced place using at least the additional information (Step S152). Specifically, the cause determination unit 120 recognizes behavior of objects and vehicles in the vicinity of the congestion induced place using at least the additional information obtained by performing image recognition processing on the intersection images. Then the cause determination unit 120 determines the congestion cause at the congestion induced place by referring to the congestion cause information stored in the cause information storage unit 122. As described above, by analyzing the intersection images and determining the congestion cause by image recognition, it becomes possible to automatically determine the congestion cause without depending on the operator's know-how.

Then the cause determination unit 120 determines whether or not the cause determination processing has been executed for all the paths 34 (Step S154). When the cause determination processing has not been executed for all the paths 34 (NO in S154), the process goes back to S142. On the other hand, when the cause determination processing has been performed for all the paths 34 (YES in S154), the cause determination unit 120 ends the processing for this intersection 40.

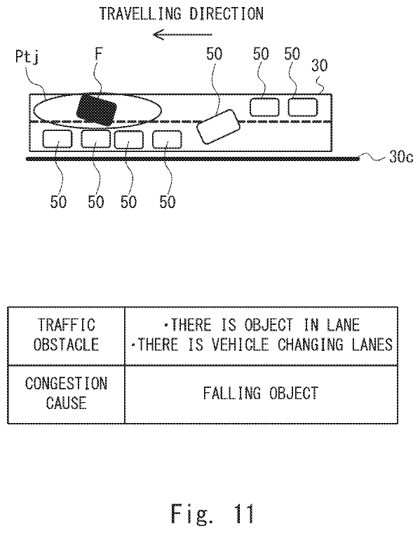

FIGS. 10 to 16 are diagrams each describing an example of the relation between the traffic obstacle and the congestion cause. FIG. 10 shows an example in a case in which the congestion cause is a “traffic accident” and a “disabled vehicle”. The cause determination unit 120 detects a traffic obstacle that stopped vehicles 50A are present in a congestion occurring place Ptj (congestion induced place) of the road 30 using the additional information. The cause determination unit 120 further detects the traffic obstacle that the speed of the subsequent vehicles 50 has suddenly reduced in a short period of time using the vehicle information. Specifically, the cause determination unit 120 detects that the average travelling speed of the vehicles 50 has been decreased by a predetermined speed (e.g., about 40 km/h) during a predetermined period of time (e.g., several minutes), as shown in a graph Gr1 indicating the change in the average travelling speed in the lane #1-1. In this case, when the number of stopped vehicles 50A is two or larger, the cause determination unit 120 determines that the congestion cause is a “traffic accident”. Further, when the number of stopped vehicles 50A is one, the cause determination unit 120 determines that the congestion cause is a “disabled vehicle”.

FIG. 11 shows an example in which the congestion cause is a “falling object”. The cause determination unit 120 detects the traffic obstacle that there is an object F other than a vehicle in the congestion occurring place Ptj (congestion induced place) on the road 30 using the additional information. Further, the cause determination unit 120 detects the traffic obstacle that the vehicles 50 are changing the lanes on the upstream side of the object F by analyzing the intersection images or using the vehicle information. In this case, the cause determination unit 120 determines that the congestion cause is a “falling object”.

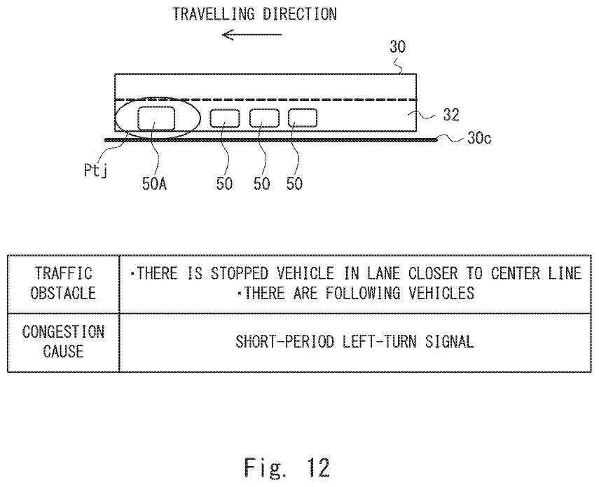

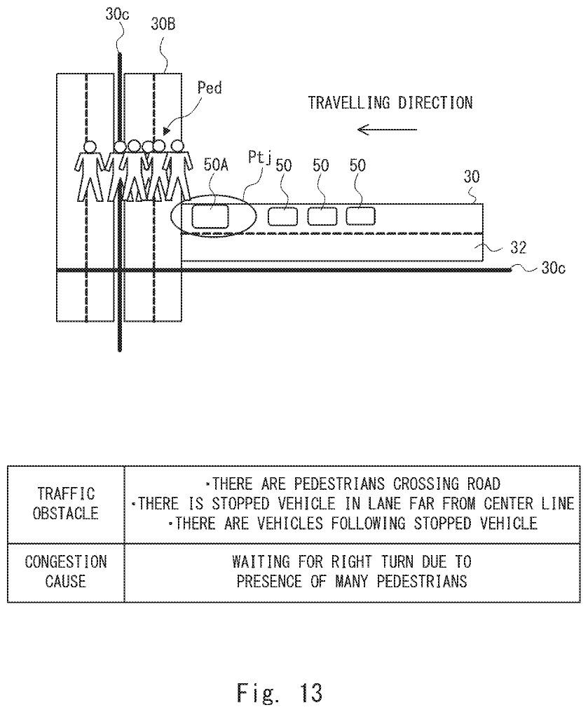

FIG. 12 shows an example in which the congestion cause is a “short-period left-turn signal”. The cause determination unit 120 detects the traffic obstacle that a stopped vehicle 50A is present in the congestion occurring place Ptj (congestion induced place) of the lane 32 that is closer to the center line 30c of the road 30 using the additional information. Further, the cause determination unit 120 detects the traffic obstacle that vehicles 50 follow the stopped vehicle 50A without changing the lanes on the upstream side of the stopped vehicle 50A by analyzing the intersection images or using the vehicle information. In this case, the cause determination unit 120 determines that the congestion cause is a “short-period left-turn signal”.

FIG. 13 shows an example in which the congestion cause is “waiting for right turn due to the presence of a number of pedestrians”. The cause determination unit 120 detects the traffic obstacle that there are a lot of pedestrians Ped whose number is larger than a predetermined number and who are crossing a road 30B that intersects with the lane 32 including the congestion occurring place Ptj (congestion induced place) using the additional information. Further, the cause determination unit 120 detects the traffic obstacle that there is a stopped vehicle 50A in the congestion occurring place Ptj (congestion induced place) of the lane 32 that is far from the center line 30c of the road 30 using the additional information. Further, the cause determination unit 120 detects the traffic obstacle that the vehicles 50 follow the stopped vehicle 50A without changing the lanes on the upstream side of the stopped vehicle 50A by analyzing the intersection images or using the vehicle information. In this case, the cause determination unit 120 determines that the congestion cause is “waiting for right turn due to the presence of a number of pedestrians”.

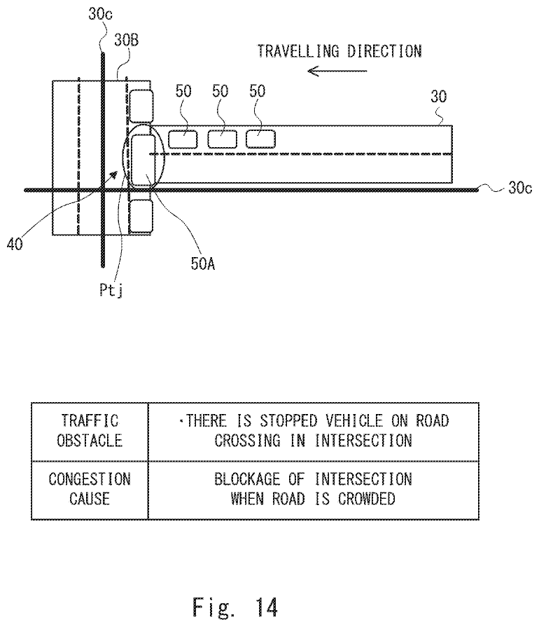

FIG. 14 shows an example in which the congestion cause is “blockage of an intersection when a road is crowded”. The cause determination unit 120 detects the traffic obstacle that a stopped vehicle 50A is present on the intersection 40 on the road 30B that intersects with the lane 32 including the congestion occurring place Ptj (congestion induced place) using the additional information. In this case, the cause determination unit 120 determines that the congestion cause is “blockage of an intersection when a road is crowded”.

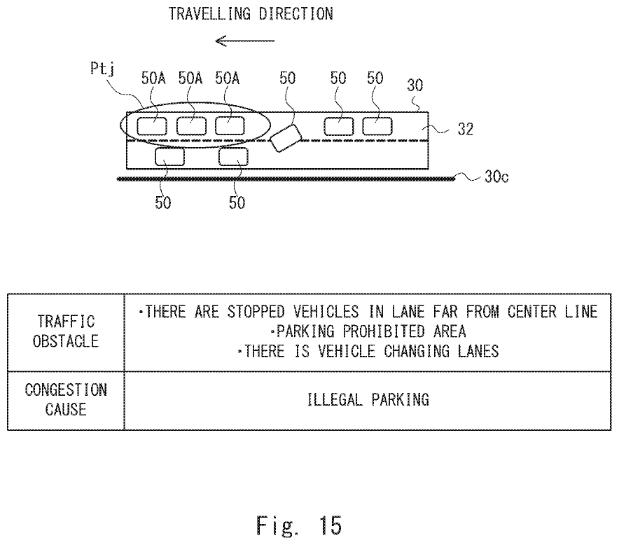

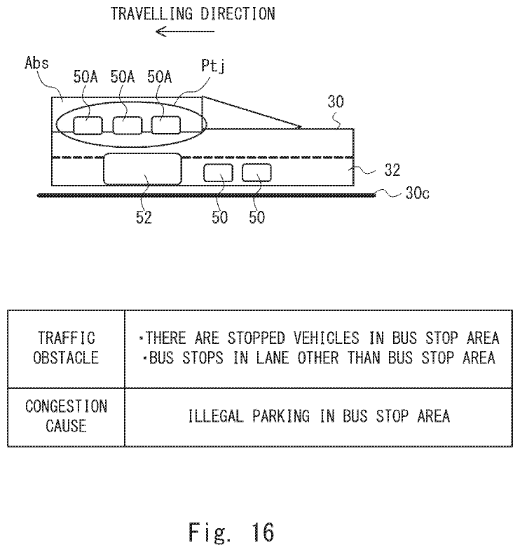

FIG. 15 shows an example in which the congestion cause is “illegal parking”. The cause determination unit 120 detects the traffic obstacle that there are stopped vehicles 50A in the congestion occurring place Ptj (congestion induced place) in the lane 32 far from the center line 30c of the road 30 using the additional information. Further, the cause determination unit 120 detects the traffic obstacle that the congestion occurring place Ptj is a parking prohibited area by using the additional information or analyzing the intersection images. Further, the cause determination unit 120 detects a traffic obstacle that the vehicles 50 are changing the lanes on the upstream side of the congestion occurring place Ptj by analyzing the intersection images or using the vehicle information. In this case, the cause determination unit 120 determines that the congestion cause is “illegal parking”.

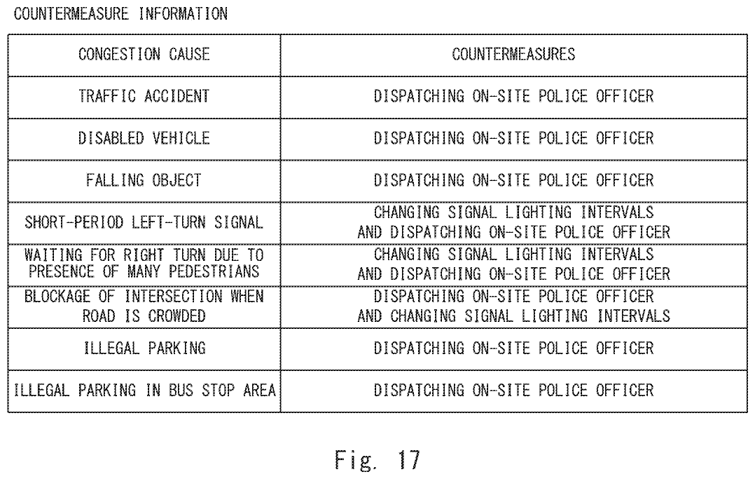

FIG. 16 shows an example in which the congestion cause is “illegal parking in a bus stop area”. The cause determination unit 120 detects the traffic obstacle that stopped vehicles 50A are present in the congestion occurring place Ptj (congestion induced place) of a bus stop area Abs using the additional information. Further, the cause determination unit 120 analyzes the intersection images and detects the traffic obstacle that a bus 52 is stopping in the lane 32 other than the bus stop area Abs. In this case, the cause determination unit 120 determines that the congestion cause is “illegal parking in a bus stop area”.

The countermeasure presenting unit 130 presents the countermeasure method against the congestion cause determined in S140 (Step S160). Specifically, the countermeasure presenting unit 130 displays the countermeasure method on the interface unit 108 using the countermeasure information stored in the countermeasure information storage unit 132.

FIG. 17 is a diagram illustrating the countermeasure information according to the first example embodiment. In the example shown in FIG. 17, when the congestion cause is a “traffic accident”, a “disabled vehicle”, or a “falling object”, the countermeasure presenting unit 130 presents a countermeasure method such as “dispatching an on-site police officer to the congestion occurring place (congestion induced place)”. Further, when the congestion cause is “short-period left-turn signal”, “waiting for right turn due to the presence of a number of pedestrians”, or “blockage of an intersection when a road is crowded”, the countermeasure presenting unit 130 presents a countermeasure method such as “changing signal lighting intervals” and “dispatching an on-site police officer to the congestion occurring place”. Further, when the congestion cause is “illegal parking” or “illegal parking in a bus stop area”, the countermeasure presenting unit 130 presents a countermeasure method such as “dispatching an on-site police officer to the congestion occurring place”.

### Outline of Second Example Embodiment

Next, a second example embodiment will be described. The second example embodiment is different from the first example embodiment in that an intersection that should be dealt with when congestion is occurred in a plurality of consecutive intersections is specified. Of the components according to the second example embodiment, components that are substantially the same as those in the first example embodiment are denoted by the same reference symbols. Further, the descriptions of the components that are substantially the same as those in the first example embodiment will be omitted as appropriate.

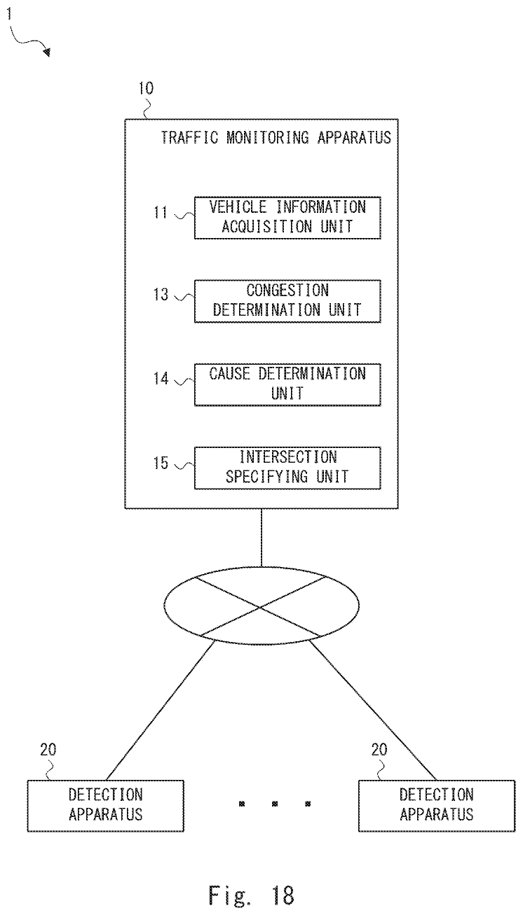

FIG. 18 is a diagram showing an outline of a traffic monitoring system 1 according to the second example embodiment of the present disclosure. The traffic monitoring system 1 according to the second example embodiment of the present disclosure includes a traffic monitoring apparatus 10 and a plurality of detection apparatuses 20. The plurality of detection apparatuses 20 and the traffic monitoring apparatus 10 are connected to each other in such a way that they can communicate with each other via a wired or wireless network.

The traffic monitoring apparatus 10 monitors traffic of a plurality of intersections where the detection apparatuses 20 are installed. The traffic monitoring apparatus 10 includes a vehicle information acquisition unit 11 (vehicle information acquisition means), a congestion determination unit 13 (congestion determination means), a cause determination unit 14 (cause determination means), and an intersection specifying unit 15 (intersection specifying means). The vehicle information acquisition unit 11 acquires, from data received from each of the plurality of detection apparatuses 20, vehicle information regarding travelling states of vehicles that are present in the vicinity of the plurality of respective intersections. The congestion determination unit 13 determines, for each of the plurality of intersections, whether or not congestion is occurring based on the vehicle information and determines an intersection where the congestion has occurred to be a congested intersection. The intersection specifying unit 15 specifies, when there is a continuous congestion path including a plurality of consecutive congested intersections, a congestion-inducing intersection, which is an intersection that has induced congestion in the continuous congestion path. The cause determination unit 14 determines the cause of the congestion that has occurred in the congestion-inducing intersection.

As described above, the traffic monitoring apparatus 10 according to the second example embodiment of the present disclosure specifies, when there is a continuous congestion path including a plurality of consecutive congested intersections, the congestion-inducing intersection, which is an intersection that has induced congestion in the continuous congestion path. Then the traffic monitoring apparatus 100 according to the second example embodiment of the present disclosure determines the cause of the congestion that has occurred in the congestion-inducing intersection. When the congestion that has occurred in the congestion-inducing intersection has spread to another intersection, it is highly likely that the original cause of the congestion has not occurred in the other intersection. Therefore, the traffic monitoring system 1 according to the second example embodiment of the present disclosure is able to determine the cause of the congestion more definitely. Therefore, it is possible to examine countermeasures against congestion more appropriately. That is, it is possible to prevent the waste of taking countermeasures against the other intersection when the congestion that has occurred in the congestion-inducing intersection has spread to the other intersection. By using the traffic monitoring system 1 according to the second example embodiment of the present disclosure as well, it becomes possible to determine the cause of the congestion more definitely. Further, by using the traffic monitoring method executed by the traffic monitoring apparatus 10 and the program that executes the traffic monitoring method according to the second example embodiment of the present disclosure as well, it becomes possible to determine the cause of the congestion more definitely.

### Second Example Embodiment

In the following description, with reference to the drawings, a second example embodiment will be described. For the sake of clarification of the description, the following description and the drawings are omitted and simplified as appropriate. Throughout the drawings, the same elements are denoted by the same reference symbols and overlapping descriptions are omitted as appropriate. Since the system configuration according to the second example embodiment is substantially similar to that shown in FIG. 2, the descriptions thereof will be omitted.

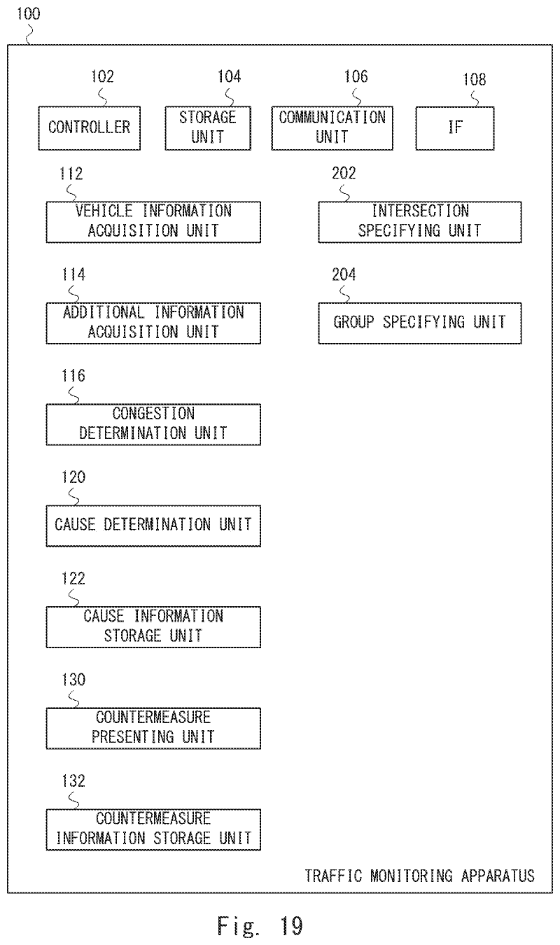

FIG. 19 is a diagram showing a configuration of a traffic monitoring apparatus 100 according to the second example embodiment. Since the hardware configuration of the traffic monitoring apparatus 100 according to the second example embodiment is substantially similar to that according to the first example embodiment, the descriptions thereof will be omitted.

Further, the traffic monitoring apparatus 100 according to the second example embodiment includes a vehicle information acquisition unit 112, an additional information acquisition unit 114, a congestion determination unit 116, a cause determination unit 120, a cause information storage unit 122, a countermeasure presenting unit 130, and a countermeasure information storage unit 132. The traffic monitoring apparatus 100 according to the second example embodiment further includes an intersection specifying unit 202 and a group specifying unit 204. The intersection specifying unit 202 and the group specifying unit 204 respectively serve as intersection specifying means and group specifying means. Unless otherwise stated, the functions of the other components are substantially similar to those according to the first example embodiment.

The congestion determination unit 116 determines, for each of the plurality of intersections 40, whether or not congestion is occurring using the vehicle information, and determines the intersection 40 where congestion has occurred to be a congested intersection. The intersection specifying unit 202 specifies, when there is a continuous congestion path including a plurality of consecutive congested intersections, the congestion-inducing intersection, which is an intersection that has induced congestion in the continuous congestion path. The cause determination unit 120 determines the cause of the congestion that has occurred in the congestion-inducing intersection. Note that the intersection specifying unit 202 may specify the congestion-inducing intersection based on the congestion level Dj calculated by the congestion determination unit 116.

The group specifying unit 204 specifies a group of a plurality of consecutive congested intersections having the congestion-inducing intersection at the top of the group in the continuous congestion path. Accordingly, it becomes possible for the operator to determine the range in which congestion may be eliminated when countermeasures are taken for the congestion-inducing intersection. In other words, the cause of the congestion of the group occurs in the vicinity of the congestion-inducing intersection.

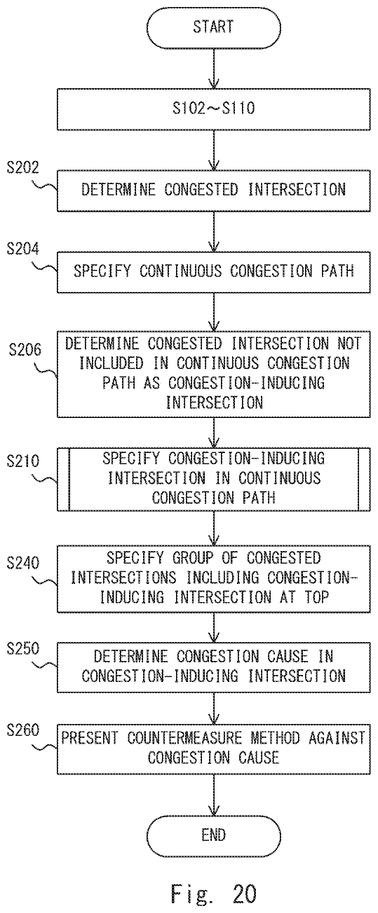

FIG. 20 is a flowchart showing a traffic monitoring method executed by the traffic monitoring apparatus 100 according to the second example embodiment. First, the traffic monitoring apparatus 100 according to the second example embodiment performs processing that is substantially similar to S102 to S110 in the flowchart shown in FIG. 6. Then the congestion determination unit 116 determines the congested intersection where the congestion has occurred (Step S202). In this case, the congestion determination unit 116 associates the congested intersection with the congestion level Dj in this congested intersection.

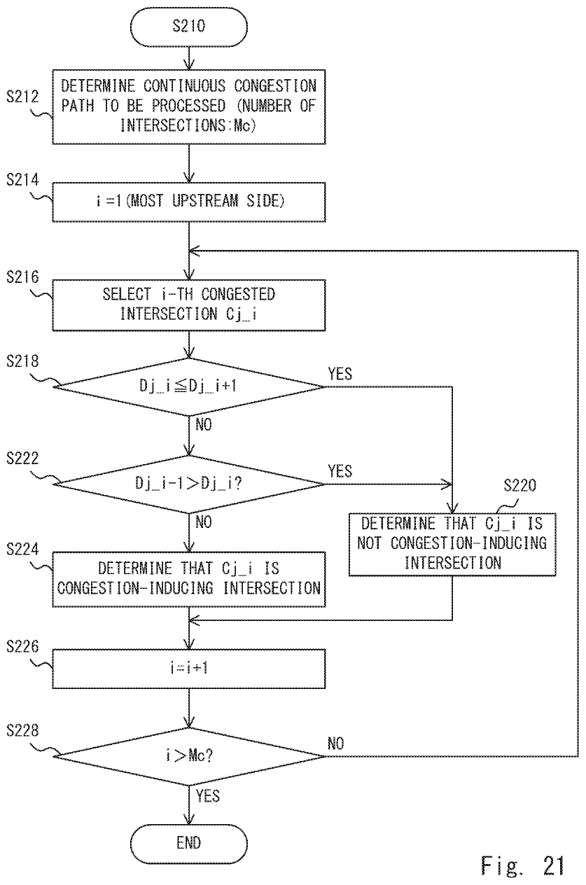

Next, the intersection specifying unit 202 specifies a continuous congestion path, which is a path formed by a continuous series of congested intersections (Step S204). Then the intersection specifying unit 202 determines whether or not each of the congested intersections is included in the continuous congestion path and determines that a congested intersection which is not included in the continuous congestion path is a congestion-inducing intersection (Step S206). Further, the intersection specifying unit 202 specifies a congestion-inducing intersection in the continuous congestion path, as will be described later with reference to FIG. 21 (Step S210).

Further, the intersection specifying unit 202 may cause the congestion-inducing intersection that has been specified to be displayed on the interface unit 108. The congestion-inducing intersection may be displayed, for example, on the map indicating the road network 4 in a noticeable way. Accordingly, the operator is able to easily recognize the congestion-inducing intersection.

FIG. 21 is a flowchart illustrating a method of specifying the congestion-inducing intersection performed by the intersection specifying unit 202 according to the second example embodiment. First, the intersection specifying unit 202 determines the continuous congestion path to be processed (Step S212). It is assumed here that the number of congested intersections included in the continuous congestion path to be processed is Mc (Mc is an integer equal to or larger than two). Then the intersection specifying unit 202 sets an initial value of i to 1, where i (i is an integer from 1 to Mc) denotes the order of the congested intersections counted from the congested intersection on the most upstream side in the continuous congestion path to be processed (Step S214). Then the intersection specifying unit 202 selects the i-th congested intersection Cj_i and sets the selected intersection as a processing target (Step S216). That is, the intersection specifying unit 202 first sets the congested intersection Cj_1 on the most upstream side as a processing target.

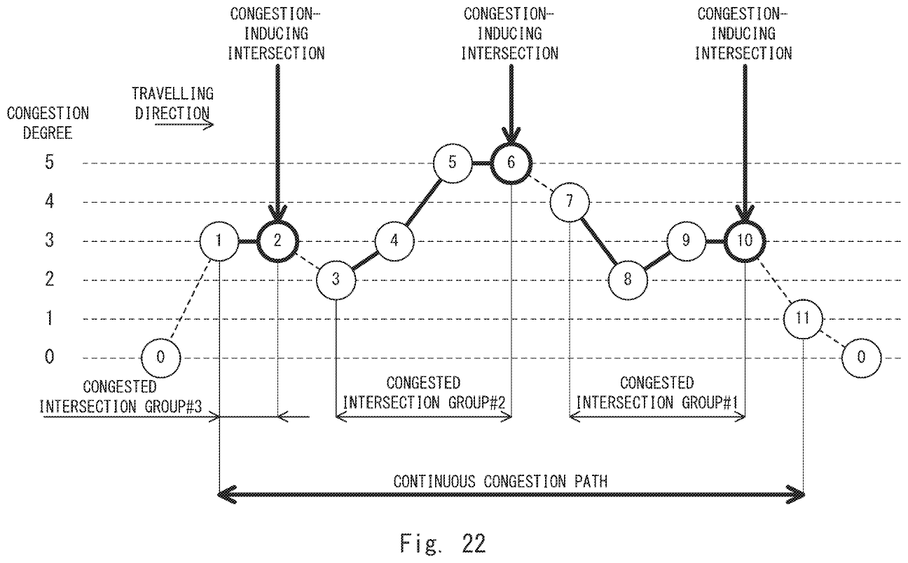

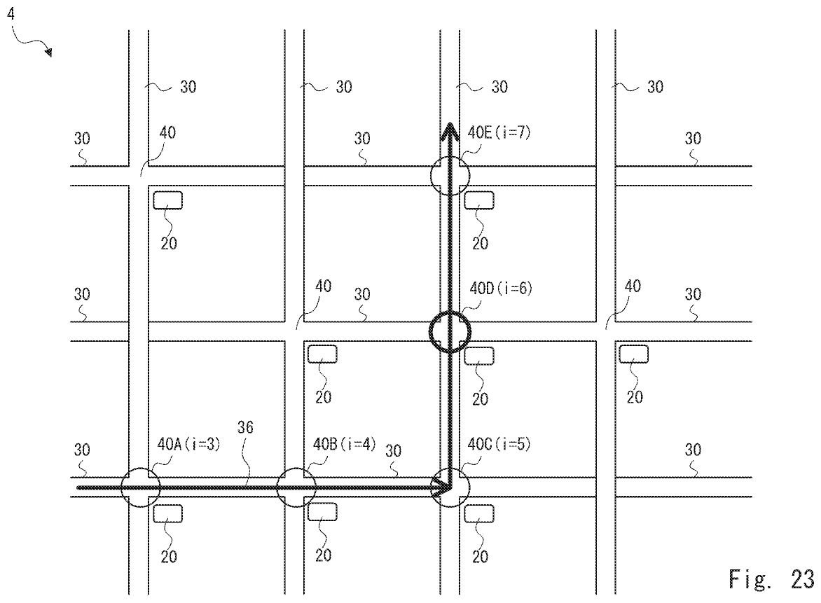

FIG. 22 is a diagram illustrating the continuous congestion path. The continuous congestion path (a series of congestions) is not limited to a straight path but may turn to the right or turn to the left in one intersection 40 (congested intersection Cj) in the road network 4 illustrated in FIG. 3 (e.g., the paths 34C and 34D in FIG. 9). In FIG. 22, the circles (∘) indicate the intersections 40 and the numbers in the respective circles indicate the order i of the congested intersections Cj counted from the upstream side in the continuous congestion path. FIG. 22 indicates the continuous congestion path including 11 (i=1 to 11) congested intersections Cj. The intersection 40 (“0” is placed inside the circle) on the left side (upstream side) of the continuous congestion path indicates the intersection 40 where congestion is not occurring, which is immediately before the continuous congestion path. Further, the intersection 40 (“0” is placed inside the circle) on the right side (downstream side) of the continuous congestion path indicates the intersection 40 where congestion is not occurring, which is immediately after the continuous congestion path.

Further, in FIG. 22, the vertical direction indicates the congestion level Dj of each of the congested intersections Cj. The congestion level Dj here indicates the congestion level regarding the travelling direction of vehicles in the continuous congestion path. For example, the congestion level Dj of the first congested intersection Cj_1 is “3”. Further, the congestion level Dj of the fifth congested intersection Cj_5 is “5”. Further, the congestion level Dj of the eleventh congested intersection Cj_11 is “1”.

The intersection specifying unit 202 determines whether or not the congestion level Dj_i of the congested intersection Cj_i to be processed is equal to or smaller than the congestion level Dj_i+1 of the following (on the downstream side) intersection Cj_i+1 (Step S218). That is, the intersection specifying unit 202 determines whether or not the congestion level Dj of the congested intersection Cj on the downstream side is higher than or the same as the congestion level Dj of the congested intersection Cj on the upstream side. The expression “the same level” here is not limited to a case in which the congestion levels Dj strictly coincide with each other. Even when there is a slight difference between the two congestion levels Dj, if the two congestion levels Dj can be regarded to be substantially the same (a small difference between them is negligible) when the levels of the congestion are determined, it can be said that they are in “the same level”.

When the congestion level Dj_i is equal to or lower than the congestion level Dj_i+1 (YES in 5218), the intersection specifying unit 202 determines that the congested intersection Cj_i to be processed is not a congestion-inducing intersection (Step S220). That is, when the congestion level Dj of the congested intersection Cj on the downstream side is higher than or the same as the congestion level Dj of the congested intersection Cj on the upstream side, the intersection specifying unit 202 determines that the congested intersection Cj on the upstream side is not a congestion-inducing intersection.

On the other hand, when the congestion level Dj_i is not equal to or smaller than the congestion level Dj_i+1 (NO in S218), the intersection specifying unit 202 determines whether or not the congestion level Dj_i of the congested intersection Cj_i to be processed is lower than the congestion level Dj_i−1 of the intersection Cj_i-1 which is just before (on the upstream side of) the congested intersection Cj_i (Step S222). When the congestion level Dj_i is lower than the congestion level Dj_i−1 (YES in S222), the intersection specifying unit 202 determines that the congested intersection Cj_i to be processed is not a congestion-inducing intersection (S220). That is, when the congestion level Dj of the congested intersection Cj on the downstream side is lower than the congestion level Dj of the congested intersection Cj on the upstream side, the intersection specifying unit 202 determines that the congested intersection Cj on the downstream side is not a congestion-inducing intersection.

On the other hand, when the congestion level Dj_i is not lower than the congestion level Dj_i−1 (NO in 5222), the intersection specifying unit 202 determines that the congested intersection Cj_i to be processed is a congestion-inducing intersection (Step S224). That is, when the congestion level Dj_i is higher than or the same as the congestion level Dj_i−1, the intersection specifying unit 202 determines that the congested intersection Cj_i to be processed is a congestion-inducing intersection. As described above, when the congestion level Dj has been lowered (improved) on the downstream side of the congested intersection Cj_i while the congestion level Dj has not been lowered (improved) on the upstream side of the congested intersection Cj_i to be processed, it is determined that the congested intersection Cj_i to be processed is a congestion-inducing intersection.

The intersection specifying unit 202 increments i by one (Step S226) and determines whether or not i>Mc is satisfied (Step S228). When i>Mc is not satisfied (NO in S228), then the process goes back to S216, and the intersection specifying unit 202 performs processing of S216 to S226, setting the following congested intersection Cj as a processing target. On the other hand, when i>Mc is satisfied (YES in S228), it is determined that processing for all the Mc congested intersections Cj in the continuous congestion path has been ended, and the processing of S110 is ended.

In the example shown in FIG. 22, when the first (i=1) congested intersection Cj_1 is a target to be processed, the intersection specifying unit 202 determines, in the processing of S218, that the congestion level Dj_1 is in the same level as the congestion level Dj_2. Therefore, it is determined that the first congested intersection Cj_1 is not a congestion-inducing intersection (S220).

Further, when the second (i=2) congested intersection Cj_2 is a target to be processed, the intersection specifying unit 202 determines, in the processing of S218, that the congestion level Dj_2 is higher than the congestion level Dj_3. In other words, it is determined that the congestion level Dj_3 of the congested intersection Cj_3 on the downstream side is lower than the congestion level Dj_2 of the congested intersection Cj_2 on the upstream side. Further, the intersection specifying unit 202 determines, in the processing of S222, that the congestion level Dj_2 is the same as the congestion level Dj_1. In other words, it is determined that the congestion level Dj_2 of the congested intersection Cj_2 to be processed is not lower than the congestion level Dj_1 of the congested intersection Cj_1 on the upstream side. Therefore, it is determined that the second congested intersection Cj_2 is a congestion-inducing intersection (S224).

Further, when the third (i=3) congested intersection Cj_3 is a target to be processed, the intersection specifying unit 202 determines, in the processing of S218, that the congestion level Dj_3 is lower than the congestion level Dj_4. Therefore, it is determined that the third congested intersection Cj_3 is not a congestion-inducing intersection (S220).

Further, when the seventh (i=7) congested intersection Cj_7 is a target to be processed, the intersection specifying unit 202 determines, in the processing of S218, that the congestion level Dj_7 is higher than the congestion level Dj_8. Further, the intersection specifying unit 202 determines, in the processing of 5222, that the congestion level Dj_7 is lower than the congestion level Dj_6. Therefore, it is determined that the seventh congested intersection Cj_7 is not a congestion-inducing intersection (S220).

As described above, in the example shown in FIG. 22, the intersection specifying unit 202 determines that the second congested intersection Cj_2, the sixth congested intersection Cj_6, and the tenth congested intersection Cj_10 from the upstream side are congestion-inducing intersections. As described above, in the example shown in FIG. 22, a plurality of congestion-inducing intersections are present in the continuous congestion path. Further, in the example shown in FIG. 22, the eleventh congested intersection Cj_11, which is at the top of the continuous congestion path, is not a congestion-inducing intersection.

As described above, in the continuous congestion path, the top congested intersection is not always a congestion-inducing intersection. Therefore, according to a technique of simply determining that the cause of the congestion is near the top of the line of congestion cars (continuous congestion path), it is possible that the congestion may not be eliminated. On the other hand, the traffic monitoring apparatus 100 according to the second example embodiment is able to appropriately specify the congestion-inducing intersection in the continuous congestion path. Therefore, the traffic monitoring apparatus 100 according to the second example embodiment is able to appropriately determine the original cause of the congestion that has occurred in the continuous congestion path.

Next, the group specifying unit 204 specifies a group of a plurality of consecutive congested intersections including the congestion-inducing intersection at the top of the group in the continuous congestion path (Step S240). Specifically, the group specifying unit 204 classifies a group of congested intersections Cj including the congestion-inducing intersection that has been specified in S210 at the top of the group and the congested intersection which is next to (on the downstream side of) the congestion-inducing intersection on the upstream side of the above congestion-inducing intersection in the vehicle travelling direction at the end of the group as one congested intersection group. Note that, regarding the congested intersection group including the congestion-inducing intersection on the most upstream side of the continuous congestion path at the top of the group, the congested intersection Cj (Cj_1) on the most upstream side of the continuous congestion path may be at the end. As described above, the group specifying unit 204 divides the continuous congestion path into one or more congested intersection groups including the congestion-inducing intersection at the top of the group. It can be said that each of the congested intersection groups is a continuous congestion path since it is a part of the continuous congestion path. Further, the processing of S240 is not processing that is absolutely necessary in the second example embodiment.

Note that the group specifying unit 204 may cause the congested intersection groups to be displayed on the interface unit 108. The congested intersection groups may be displayed, for example, on the map indicating the road network 4 in a noticeable way. Accordingly, the operator is able to easily recognize the congested intersection groups. Accordingly, the operator is able to easily recognize which area of congestion may be eliminated by taking countermeasures against the congestion for the congestion-inducing intersection.

In the example shown in FIG. 22, the group specifying unit 204 specifies a congested intersection group #1 including the tenth congested intersection Cj_10 from the upstream side at the top and the seventh congested intersection Cj_7 from the upstream side at the end. Further, the group specifying unit 204 specifies a congested intersection group #2 including the sixth congested intersection Cj_6 from the upstream side at the top and the third congested intersection Cj_3 from the upstream side at the end. Further, the group specifying unit 204 specifies a congested intersection group #3 including the second congested intersection Cj_2 from the upstream side at the top and the first congested intersection Cj_1 from the upstream side at the end. As described above, the group specifying unit 204 divides the continuous congestion path into three groups.

Accordingly, the operator is able to easily recognize that the congestion in the congested intersection group #1 may be eliminated if countermeasures against the congestion cause are taken for the tenth congested intersection Cj_10 from the upstream side. Further, the operator is able to easily recognize that the congestion in the congested intersection group #2 may be eliminated if countermeasures against the congestion cause are taken for the sixth congested intersection Cj_6 from the upstream side. Further, the operator is able to easily recognize that the congestion in the congested intersection group #3 may be eliminated if countermeasures against the congestion cause are taken for the second congested intersection Cj_2 from the upstream side.

Next, the cause determination unit 120 determines the cause of the congestion that has occurred in the congestion-inducing intersection (Step S250). Specifically, the cause determination unit 120 may determine the congestion cause of the congestion-inducing intersection by performing processing substantially similar to the processing of S152 in FIG. 8. Then the countermeasure presenting unit 130 presents the countermeasure method against the congestion cause determined in S250 using the countermeasure information, similar to the processing of S160 in FIG. 6 (Step S260). Accordingly, the operator is able to easily examine the countermeasures against the cause of the congestion that has occurred in the congestion-inducing intersection. Therefore, it becomes possible to take countermeasures against congestion in the continuous congestion path (congested intersection group) more efficiently.

FIG. 23 is a diagram showing an example of the continuous congestion path in the road network 4. In the example shown in FIG. 23, in intersections 40A, 40B, 40C, 40D, and 40E, a series of congestions (a continuous congestion path 36) with the intersection 40A on the upstream side and the intersection 40E on the downstream side is occurring. Further, the continuous congestion path 36 is turning to the left in the intersection 40C.

Assume here that the intersections 40A, 40B, 40C, 40D, and 40E respectively correspond to the third, the fourth, the fifth, the sixth, and the seventh congested intersections Cj from the upstream side in FIG. 22. In this case, in the continuous congestion path 36, the intersection 40D is a congestion-inducing intersection. That is, congestion is alleviated more in the intersection 40E which is on the downstream side of the intersection 40D than in the intersection 40D. Therefore, in this case, when countermeasures are taken for the intersection 40D, which is the congestion-inducing intersection, congestion may be eliminated also in the intersections 40C, 40B, and 40A, which are congested intersections on the upstream side of the intersection 40D. In other words, even when countermeasures against congestion are taken in the intersections 40C, 40B, and 40A, it is possible that the congestion in these intersections 40 may not be eliminated. As described above, the traffic monitoring apparatus 100 according to the second example embodiment is able to prevent the waste of dispatching, for example, an on-site police officer to the intersection 40C just because congestion is occurring, for example, in the intersection 40C.

### MODIFIED EXAMPLES

Note that the present disclosure is not limited to the aforementioned example embodiments and may be changed as appropriate without departing from the spirit of the present disclosure. For example, in the aforementioned flowcharts, the order of each process (step) may be changed as appropriate. Further, one or more of the plurality of processes (steps) may be omitted. For example, the process of S160 in FIG. 6 may be omitted. Further, one or more of the processes of S114, S118, and S122 in FIG. 7 may be omitted. Further, the process of S222 in FIG. 21 may be omitted. However, by performing the processing of S222, it is possible to determine the congestion-inducing intersection more appropriately.

Further, while the cause information storage unit 122 and the countermeasure information storage unit 132 are provided in the traffic monitoring apparatus 100 in the aforementioned example embodiments, the configuration thereof is not limited thereto. The cause information storage unit 122 and the countermeasure information storage unit 132 may not be provided in the traffic monitoring apparatus 100. The cause information storage unit 122 and the countermeasure information storage unit 132 may be provided in an apparatus that can communicate with the traffic monitoring apparatus 100.

Further, while the countermeasure presenting unit 130 is configured to display the countermeasure method by images or the like in such a way that it can be visually recognized in the aforementioned example embodiments, the configuration thereof is not limited thereto. The countermeasure presenting unit 130 may present the countermeasure method by voices.

In the aforementioned examples, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the example embodiments disclosed above can be described as, but not limited to, the following supplementary notes.

### (Supplementary Note 1)

A traffic monitoring apparatus comprising: vehicle information acquisition means for acquiring vehicle information regarding travelling states of vehicles that are present in the vicinity of a plurality of respective intersections;

congestion determination means for determining, for each of the plurality of intersections, whether or not congestion is occurring based on the vehicle information and determining an intersection where the congestion has occurred to be a congested intersection;

intersection specifying means for specifying, when there is a continuous congestion path including a plurality of consecutive congested intersections, a congestion-inducing intersection, which is an intersection that has induced congestion in the continuous congestion path; and

cause determination means for determining the cause of the congestion that has occurred in the congestion-inducing intersection.

### (Supplementary Note 2)

The traffic monitoring apparatus according to Supplementary Note 1, wherein

the congestion determination means calculates a congestion level indicating a level of congestion of each of the intersections based on the vehicle information, and

the intersection specifying means specifies the congestion-inducing intersection based on the congestion level.

### (Supplementary Note 3)

The traffic monitoring apparatus according to Supplementary Note 2, wherein the intersection specifying means determines, when the congestion level of the congested intersection on a downstream side is higher than or in the same as the congestion level of the congested intersection on an upstream side in a vehicle travelling direction in the continuous congestion path, that the intersection on the upstream side is not the congestion-inducing intersection.

### (Supplementary Note 4)

The traffic monitoring apparatus according to Supplementary Note 3, wherein the intersection specifying means determines, when the congestion level of the congested intersection on a downstream side is lower than the congestion level of the congested intersection on an upstream side in a vehicle travelling direction in the continuous congestion path, that the intersection on the upstream side is the congestion-inducing intersection.

### (Supplementary Note 5)

The traffic monitoring apparatus according to any one of Supplementary Notes 1 to 4, further comprising group specifying means for specifying a group of a plurality of consecutive congested intersections having the congestion-inducing intersection at the top of the group in the continuous congestion path.

### (Supplementary Note 6)

The traffic monitoring apparatus according to any one of Supplementary Notes 1 to 5, further comprising countermeasure presenting means for presenting a countermeasure method against the cause of the congestion that has been determined by the cause determination means using countermeasure information in which the cause of the congestion and the countermeasure method are associated with each other.

### (Supplementary Note 7)

A traffic monitoring system comprising:

a plurality of detection apparatuses configured to detect states of areas in the vicinity of respective intersections; and

a traffic monitoring apparatus configured to monitor traffic of the intersections, wherein

the traffic monitoring apparatus comprises:

vehicle information acquisition means for acquiring vehicle information regarding travelling states of vehicles that are present in the vicinity of a plurality of respective intersections;

congestion determination means for determining, for each of the plurality of intersections, whether or not congestion is occurring based on the vehicle information and determining an intersection where the congestion has occurred to be a congested intersection;

intersection specifying means for specifying, when there is a continuous congestion path including a plurality of consecutive congested intersections, a congestion-inducing intersection, which is an intersection that has induced congestion in the continuous congestion path; and

cause determination means for determining the cause of the congestion that has occurred in the congestion-inducing intersection.

### (Supplementary Note 8)

The traffic monitoring system according to Supplementary Note 7, wherein

the congestion determination means calculates a congestion level indicating a level of congestion of each of the intersections based on the vehicle information, and

the intersection specifying means specifies the congestion-inducing intersection based on the congestion level.

### (Supplementary Note 9)

The traffic monitoring system according to Supplementary Note 8, wherein the intersection specifying means determines, when the congestion level of the congested intersection on a downstream side is higher than or in the same as the congestion level of the congested intersection on an upstream side in a vehicle travelling direction in the continuous congestion path, that the intersection on the upstream side is not the congestion-inducing intersection.

### (Supplementary Note 10)

The traffic monitoring system according to Supplementary Note 9, wherein the intersection specifying means determines, when the congestion level of the congested intersection on a downstream side is lower than the congestion level of the congested intersection on an upstream side in a vehicle travelling direction in the continuous congestion path, that the intersection on the upstream side is the congestion-inducing intersection.

### (Supplementary Note 11)

The traffic monitoring system according to any one of Supplementary Notes 7 to 10, wherein the traffic monitoring apparatus comprises group specifying means for specifying a group of a plurality of consecutive congested intersections having the congestion-inducing intersection at the top of the group in the continuous congestion path.

### (Supplementary Note 12)

The traffic monitoring system according to any one of Supplementary Notes 7 to 11, wherein the traffic monitoring apparatus further comprises countermeasure presenting means for presenting a countermeasure method against the cause of the congestion determined by the cause determination means using countermeasure information in which the cause of the congestion and the countermeasure method are associated with each other.

### (Supplementary Note 13)

A traffic monitoring method comprising:

acquiring vehicle information regarding travelling states of vehicles that are present in the vicinity of a plurality of respective intersections;

determining, for each of the plurality of intersections, whether or not congestion is occurring based on the vehicle information and determining an intersection where the congestion has occurred to be a congested intersection;

specifying, when there is a continuous congestion path including a plurality of consecutive congested intersections, a congestion-inducing intersection, which is an intersection that has induced congestion in the continuous congestion path; and

determining the cause of the congestion that has occurred in the congestion-inducing intersection.

### (Supplementary Note 14)

The traffic monitoring method according to Supplementary Note 13, comprising:

calculating a congestion level indicating a level of congestion in each of the intersections based on the vehicle information; and

specifying the congestion-inducing intersection based on the congestion level.

### (Supplementary Note 15)

The traffic monitoring method according to Supplementary Note 14, comprising determining, when the congestion level of the congested intersection on a downstream side is higher than or in the same as the congestion level of the congested intersection on an upstream side in a vehicle travelling direction in the continuous congestion path, that the intersection on the upstream side is not the congestion-inducing intersection.

### (Supplementary Note 16)

The traffic monitoring method according to Supplementary Note 15, comprising determining, when the congestion level of the congested intersection on a downstream side is lower than the congestion level of the congested intersection on an upstream side in a vehicle travelling direction in the continuous congestion path, that the intersection on the upstream side is the congestion-inducing intersection.

### (Supplementary Note 17)

The traffic monitoring method according to any one of Supplementary Notes 13 to 16, comprising specifying a group of a plurality of consecutive congested intersections having the congestion-inducing intersection at the top of the group in the continuous congestion path.

### (Supplementary Note 18)

The traffic monitoring method according to any one of Supplementary Notes 13 to 17, comprising presenting a countermeasure method against the cause of the congestion that has been determined using countermeasure information in which the cause of the congestion and the countermeasure method are associated with each other.

### (Supplementary Note 19)

A non-transitory computer readable medium storing a program for causing a computer to execute the following steps of:

acquiring vehicle information regarding travelling states of vehicles that are present in the vicinity of a plurality of respective intersections;

determining, for each of the plurality of intersections, whether or not congestion is occurring based on the vehicle information and determining an intersection where the congestion has occurred to be a congested intersection;

specifying, when there is a continuous congestion path including a plurality of consecutive congested intersections, a congestion-inducing intersection, which is an intersection that has induced congestion in the continuous congestion path; and

determining the cause of the congestion that has occurred in the congestion-inducing intersection.

While the present disclosure has been described with reference to the example embodiments, the present disclosure is not limited by the above example embodiments. Various changes that may be understood by those skilled in the art may be made to the configurations and the details of the present disclosure within the scope of the present disclosure.

This application is based upon and claims the benefit of priority from Japanese Patent Application No. 2018-066013, filed on Mar. 29, 2018, the disclosure of which is incorporated herein in its entirety by reference.

### REFERENCE SIGNS LIST

1 Traffic Monitoring System
10 Traffic Monitoring Apparatus
11 Vehicle Information Acquisition Unit
12 Additional Information Acquisition Unit
13 Congestion Determination Unit
14 Cause Determination Unit
15 Intersection Specifying Unit
20 Detection Apparatus
100 Traffic Monitoring Apparatus
112 Vehicle Information Acquisition Unit
114 Additional Information Acquisition Unit
116 Congestion Determination unit
120 Cause Determination Unit
122 Cause Information Storage Unit
130 Countermeasure Presenting Unit
132 Countermeasure Information Storage Unit
202 Intersection Specifying Unit
204 Group Specifying Unit

1. A traffic monitoring apparatus comprising:
hardware, including a processor and memory;
a vehicle information acquisition unit implemented at least by the hardware and configured to acquire vehicle information regarding travelling states of vehicles that are present in the vicinity of a plurality of respective intersections;
a congestion determination unit implemented at least by the hardware and configured to determine, for each of the plurality of intersections, whether or not congestion is occurring based on the vehicle information and determining an intersection where the congestion has occurred to be a congested intersection;
an intersection specifying unit implemented at least by the hardware and configured to specify, when there is a continuous congestion path including a plurality of consecutive congested intersections, a congestion-inducing intersection, which is an intersection that has induced congestion in the continuous congestion path; and
a cause determination unit implemented at least by the hardware and configured to determine the cause of the congestion that has occurred in the congestion-inducing intersection.

2. The traffic monitoring apparatus according to claim 1, wherein
the congestion determination unit calculates a congestion level indicating a level of congestion of each of the intersections based on the vehicle information, and
the intersection specifying unit specifies the congestion-inducing intersection based on the congestion level.

3. The traffic monitoring apparatus according to claim 2, wherein the intersection specifying unit determines, when the congestion level of the congested intersection on a downstream side is higher than or in the same as the congestion level of the congested intersection on an upstream side in a vehicle travelling direction in the continuous congestion path, that the intersection on the upstream side is not the congestion-inducing intersection.

4. The traffic monitoring apparatus according to claim 3, wherein the intersection specifying unit determines, when the congestion level of the congested intersection on a downstream side is lower than the congestion level of the congested intersection on an upstream side in a vehicle travelling direction in the continuous congestion path, that the intersection on the upstream side is the congestion-inducing intersection.

5. The traffic monitoring apparatus according to claim 1, further comprising a group specifying unit implemented at least by the hardware and configured to specify a group of a plurality of consecutive congested intersections having the congestion-inducing intersection at the top of the group in the continuous congestion path.

6. The traffic monitoring apparatus according to claim 1, further comprising a countermeasure presenting unit implemented at least by the hardware and configured to present a countermeasure method against the cause of the congestion that has been determined by the cause determination unit using countermeasure information in which the cause of the congestion and the countermeasure method are associated with each other.

7. A traffic monitoring system comprising:
a plurality of detection apparatuses configured to detect states of areas in the vicinity of respective intersections; and
the traffic monitoring apparatus according to claim 1.

8. The traffic monitoring system according to claim 7, wherein
the congestion determination unit calculates a congestion level indicating a level of congestion of each of the intersections based on the vehicle information, and
the intersection specifying unit specifies the congestion-inducing intersection based on the congestion level.

9. The traffic monitoring system according to claim 8, wherein the intersection specifying unit determines, when the congestion level of the congested intersection on a downstream side is higher than or in the same as the congestion level of the congested intersection on an upstream side in a vehicle travelling direction in the continuous congestion path, that the intersection on the upstream side is not the congestion-inducing intersection.

10. The traffic monitoring system according to claim 9, wherein the intersection specifying unit determines, when the congestion level of the congested intersection on a downstream side is lower than the congestion level of the congested intersection on an upstream side in a vehicle travelling direction in the continuous congestion path, that the intersection on the upstream side is the congestion-inducing intersection.

11. The traffic monitoring system according to claim 7, wherein the traffic monitoring apparatus comprises a group specifying unit implemented at least by the hardware and configured to specifying a group of a plurality of consecutive congested intersections having the congestion-inducing intersection at the top of the group in the continuous congestion path.

12. The traffic monitoring system according to claim 7, wherein the traffic monitoring apparatus further comprises a countermeasure presenting unit implemented at least by the hardware and configured to present a countermeasure method against the cause of the congestion determined by the cause determination unit using countermeasure information in which the cause of the congestion and the countermeasure method are associated with each other.

13. A traffic monitoring method comprising:
acquiring vehicle information regarding travelling states of vehicles that are present in the vicinity of a plurality of respective intersections;
determining, for each of the plurality of intersections, whether or not congestion is occurring based on the vehicle information and determining an intersection where the congestion has occurred to be a congested intersection;
specifying, when there is a continuous congestion path including a plurality of consecutive congested intersections, a congestion-inducing intersection, which is an intersection that has induced congestion in the continuous congestion path; and
determining the cause of the congestion that has occurred in the congestion-inducing intersection.

14. The traffic monitoring method according to claim 13, comprising:
calculating a congestion level indicating a level of congestion in each of the intersections based on the vehicle information; and
specifying the congestion-inducing intersection based on the congestion level.

15. The traffic monitoring method according to claim 14, comprising determining, when the congestion level of the congested intersection on a downstream side is higher than or in the same as the congestion level of the congested intersection on an upstream side in a vehicle travelling direction in the continuous congestion path, that the intersection on the upstream side is not the congestion-inducing intersection.

16. The traffic monitoring method according to claim 15, comprising determining, when the congestion level of the congested intersection on a downstream side is lower than the congestion level of the congested intersection on an upstream side in a vehicle travelling direction in the continuous congestion path, that the intersection on the upstream side is the congestion-inducing intersection.

17. The traffic monitoring method according to claim 13, comprising specifying a group of a plurality of consecutive congested intersections having the congestion-inducing intersection at the top of the group in the continuous congestion path.

18. The traffic monitoring method according to claim 13, comprising presenting a countermeasure method against the cause of the congestion that has been determined using countermeasure information in which the cause of the congestion and the countermeasure method are associated with each other.

19. (canceled)
